(19) United States
(12) Patent Application Publication
(10) Pub. No.: US 2009/0003434 A1
(43) Pub. Date: Jan. 1, 2009

(54) METHOD AND APPARATUS FOR COMPOSING SCENE USING LASeR CONTENTS

(75) Inventors: Jae-Yeon SONG, Seoul (KR); Seo-Young Hwang, Suwon-si (KR); Young-Kwon Lim, Goyang-si (KR); Kook-Heui Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/147,052

(22) Filed: Jun. 26, 2008

(30) Foreign Application Priority Data
Jun. 26, 2007 (KR) 63347-2007
Oct. 16, 2007 (KR) 104254-2007
Apr. 21, 2008 (KR) 36886-2008
Apr. 30, 2008 (KR) 40314-2008

(51) Int. Cl. H04N 11/02; H04N 7/173

(52) U.S. Cl. 375/240.01; 725/118; 725/131; 375/E07.076

(57) ABSTRACT

A method and apparatus for transmitting and receiving LASeR contents are provided, in which content including at least one of a scene element and a scene element set that includes the scene element is received, for use in scene composition, and a scene is composed by selecting at least one of the at least one of the scene element and the scene element set included in the content according to at least one of a terminal type, a user preference, and a content-serviced party.

### PRIORITY

This application claims priority under 35 U.S.C. § 119(a) to a Korean Patent Application filed in the Korean Intellectual Property Office on Jun. 26, 2007 and assigned Serial No. 2007-63347, a Korean Patent Application filed in the Korean Intellectual Property Office on Oct. 16, 2007 and assigned Serial No. 2007-104254, a Korean Patent Application filed in the Korean Intellectual Property Office on Apr. 21, 2008 and assigned Serial No. 2008-36886, and a Korean Patent Application filed in the Korean Intellectual Property Office on Apr. 30, 2008 and assigned Serial No. 2008-40314, the entire disclosures of any of which are hereby incorporated by reference.

### BACKGROUND OF THE INVENTION

1. Field of the Invention

The present invention generally relates to a method and apparatus for composing a scene. More particularly, the present invention relates to a method and apparatus for composing a scene using Lightweight Application Scene Representation (LASeR) contents.

2. Description of the Related Art

LASeR is a multimedia content format created to enable multimedia service in a communication environment suffering from resource shortages such as mobile phones. Many technologies have recently been considered for multimedia service. Moving Picture Experts Group-4 Binary Format for Scene (MPEG-4 BIFS) is under implementation via a variety of media as a scene description standard for multimedia content.

BIFS is a scene description standard set forth for free representation of object-oriented multimedia content and interaction with users. BIFS can represent two-dimensional and three-dimensional graphics in a binary format. Since a BIFS multimedia scene is composed of a plurality of objects, it is necessary to describe the temporal and spatial locations of each object. For example, a weather forecast scene can be partitioned into four objects, a weather caster, a weather chart displayed behind the weather caster, speech of the weather caster, and background music. When these objects are presented independently, the appearance and disappearance times and position of each object should be defined to describe a weather forecast scene. BIFS sets these pieces of information. As BIFS stores the information in a binary file, it reduces memory capacity requirements.

However, due to a huge amount of data, BIFS is not viable in a communication system suffering from available resource shortages, such as mobile phone. In this context, ISO/IEC 14496-20: MPEG-4 LASeR was proposed as an alternative to BIFS free representation of various multimedia and interactions with users through complexity minimization by scene description, video, audio, images, fonts, and data like meta data in mobile phones having limitations in memory and power. LASeR data is composed of an access unit including a command. The command is used to change a scene characteristic at a given time instant. Simultaneous commands are grouped in one access unit. The access unit can be one scene, sound, or short animation.

The standardization for convergence between LASeR and WorldWide Web Consortium (W3C) is ongoing, using the Scalable Vector Graphics (SVG) and Synchronized Multimedia Integration Language (SMIL) standards of W3C. Since SVG mathematically describes an image, SVG allows images to be viewed on a computer display with any resolution irrespective of screen size and effectively represents images with a small amount of data. SMIL defines and represents the temporal and spatial relationship of multimedia data. Hence, text, images, polyhedrons, audio, and video can be represented by SVG and SMIL.

The current technology trend is that networks are converged such as Convergence of Broadcasting and Mobile Service (DVB-CBMS) or Internet Protocol TV (IPTV). A network model is possible, in which different types of terminals are connected over a single network. If a single integration service provider manages a network formed by wired/wireless convergence of a wired IPTV, the same service can be provided to terminals irrespective of their types. In this business model, particularly when a broadcasting service and the same multimedia service are provided to various terminals, one LASeR scene is provided to them ranging from terminals with large screens (e.g. laptop) to terminals with small screens. If a scene is optimized for the screen size of a hand-held phone, the scene can be composed relatively easily. If a scene is optimized for a terminal with a large screen such as a computer, a relatively rich scene will be composed.

Also, when a channel mosaic service is provided by multiplexing a plurality of logical channels Channel A to Channel F corresponding to a plurality of channels into one logical channel as illustrated in FIG. 8, each channel is segmented again for a mobile terminal with a much smaller screen size than an existing broadcasting terminal or a Personal Computer (PC). In this case, the stream contents of a channel in service may not be identified. Therefore, when the mosaic service is provided to different types of terminals in an integrated network, terminals with a large screen can serve the mosaic service, but mobile phones cannot serve the mosaic service efficiently for the above-described reason. Accordingly, there exists a need for a function that does not provide the mosaic service to mobile phones, that is, does not select mosaic scenes for mobile phones and provides mosaic scenes to terminals with a large screen, according to the types of terminals.

Hence, a function for enabling composition of a plurality of scenes from one content and selecting a scene element according to a terminal type is needed to optimize a scene composition according to the terminal type.

Especially in a broadcasting service, a single broadcasting stream is simultaneously transmitted to different types of terminals with different screen sizes, different performances, and different characteristics. Therefore, it is impossible to optimize a scene element according to the type of each terminal as to in a point-to-point manner. Accordingly, there exists a need for a method and apparatus for composing a scene using LASeR contents according to the type of each terminal in a LASeR service.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a method and apparatus for composing a scene according to the type of a terminal in a LASeR service.

Another aspect of exemplary embodiments of the present invention provides a method and apparatus for composing a scene according to a change in the type of a terminal in a LASeR service.

In accordance with a first aspect of exemplary embodiments of the present invention, there is provided a method for transmitting a content, in which a content is generated, which includes at least one of a scene element and a scene element set that includes the scene element, for use in scene composition according to at least one of a terminal type, a user preference, and a content-serviced party.

In accordance with a second aspect of exemplary embodiments of the present invention, there is provided an apparatus for transmitting a content, in which a contents generator generates a content which includes at least one of a scene element and a scene element set that includes the scene element, for use in scene composition according to at least one of a terminal type, a user preference, and a content-serviced party, an encoder encodes the content, and a transmitter transmits the encoded content.

In accordance with a third aspect of exemplary embodiments of the present invention, there is provided a method for receiving a content, a content is received, which includes at least one of a scene element and a scene element set that includes the scene element, for use in scene composition according to at least one of a terminal type, a user preference, and a content-serviced party, and a scene is composed by selecting at least one of the at least one of the scene element and the scene element set included in the content according to the at least one of the terminal type, the user preference, and the content-serviced party.

In accordance with a fourth aspect of exemplary embodiments of the present invention, there is provided an apparatus for receiving a content, in which a receiver receives a content including at least one of a scene element and a scene element set that includes the scene element, for use in scene composition according to at least one of a terminal type, a user preference, and a content-serviced party, a scene composition controller selects at least one of the at least one of the scene element and the scene element set included in the content according to the at least one of the terminal type, the user preference, and the content-serviced party, and a scene composer composes a scene using the selected at least one of the at least one of the scene element and the scene element set.

In accordance with a fifth aspect of exemplary embodiments of the present invention, there is provided a method for transmitting a content, in which a content is generated, which includes at least one of a scene element and a scene element set that includes the scene element, for use in scene composition, a content is generated, which includes at least one of a scene element and a scene element set having the scene element according to an event indicating a change in at least one of a terminal type, a user preference, and a content-serviced party, when generation of the event is notified of by a receiver, and the contents are encoded and transmitted.

In accordance with a sixth aspect of exemplary embodiments of the present invention, there is provided an apparatus for transmitting a content, in which a contents generator generates a content including at least one of a scene element and a scene element set that includes the scene element, for use in scene composition, and generates a content including at least one of a scene element and a scene element set having the scene element according to an event indicating a change in at least one of a terminal type, a user preference, and a content-serviced party, when generation of the event is notified of by a receiver, an encoder encodes the contents, and a transmitter transmits the encoded contents.

In accordance with a seventh aspect of exemplary embodiments of the present invention, there is provided a method for receiving a content, in which a content is received, a scene is composed according to a scene composition indicated by the content, and a scene is composed by selecting at least one of a scene element and a scene element set included in the content according to an event indicating a change in at least one of a terminal type, a user preference, and a content-serviced party, when the event occurs.

In accordance with an eighth aspect of exemplary embodiments of the present invention, there is provided an apparatus for receiving a content, in which a receiver receives a content, a scene composition controller selects at least one of a scene element and a scene element set included in the content according to an event indicating a change in at least one of a terminal type, a user preference, and a content-serviced party, when the event occurs, and a scene composer composes a scene using the selected at least one of the scene element and the scene element set.

In accordance with a ninth aspect of exemplary embodiments of the present invention, there is provided a method for transmitting a content, in which a content is generated, which includes at least one of a scene element and a scene element set that includes the scene element, and priority levels of scene elements, for use in scene composition.

In accordance with a tenth aspect of exemplary embodiments of the present invention, there is provided an apparatus for transmitting a content, in which a content generator generates a content including at least one of a scene element and a scene element set that includes the scene element, and priority levels of scene elements, for use in scene composition, an encoder encodes the content, and a transmitter transmits the encoded content.

In accordance with a eleventh aspect of exemplary embodiments of the present invention, there is provided a method for receiving a content, in which a content is received, which includes at least one of a scene element and a scene element set that includes the scene element, and priority levels of scene elements, for use in scene composition, and a scene is composed by selecting at least one of the at least one of the scene element and the scene element set, and the priority levels of scene elements according to at least one of a terminal type, a user preference, and a content-serviced party.

In accordance with a twelfth aspect of exemplary embodiments of the present invention, there is provided an apparatus for receiving a content, in which a receiver receives a content including at least one of a scene element and a scene element set that includes the scene element, and priority levels of scene elements, for use in scene composition, a scene composition controller selects at least one of the at least one of the scene element and the scene element set, and the priority levels of scene elements according to at least one of a terminal type, a user preference, and a content-serviced party, and a scene composer composes a scene using the selected at least one of the at least one of the scene element and the scene element set, and the priority levels of scene elements.

In accordance with a thirteenth aspect of exemplary embodiments of the present invention, there is provided a method for transmitting a content, in which a content is generated, which includes at least one of a scene element and a scene element set that includes the scene element, and at least one alternative scene element for substituting for the at least one of the scene element and the scene element set, for use in scene composition, encoded, and transmitted.

In accordance with a fourteenth aspect of exemplary embodiments of the present invention, there is provided an apparatus for transmitting a content, in which a contents generator generates a content including at least one of a scene element and a scene element set that includes the scene element, and at least one alternative scene element for substituting for the at least one of the scene element and the scene element set, for use in scene composition, an encoder encodes the content, and a transmitter transmits the encoded content.

In accordance with a fifteenth aspect of exemplary embodiments of the present invention, there is provided a method for receiving a content, in which a content is received, which includes at least one of a scene element and a scene element set that includes the scene element, and at least one alternative scene element for substituting for the at least one of the scene element and the scene element set, for use in scene composition, and a scene is composed by selecting at least one of the at least one of the scene element and the scene element set and the at least one alternative scene element according to at least one of a terminal type, a user preference, and a content-serviced party.

In accordance with a sixteenth aspect of exemplary embodiments of the present invention, there is an apparatus for receiving a content, in which a receiver receives a content including at least one of a scene element and a scene element set that includes the scene element, and at least one alternative scene element for substituting for the at least one of the scene element and the scene element set, for use in scene composition, a scene composition controller selects at least one of the at least one of the scene element and the scene element set and the at least one alternative scene element according to at least one of a terminal type, a user preference, and a content-serviced party, and a scene composer composes a scene using the selected at least one of the at least one of the scene element and the scene element set and the at least one alternative scene element.

In accordance with a seventeenth aspect of exemplary embodiments of the present invention, there is a method for transmitting a content, in which a content is generated, which includes at least one of a scene element and a scene element set that includes the scene element, for use in scene composition.

In accordance with an eighteenth aspect of exemplary embodiments of the present invention, there is an apparatus for transmitting a content, in which a contents generator generates a content including at least one of a scene element and a scene element set that includes the scene element, for use in scene composition, an encoder encodes the content, and a transmitter transmits the encoded content.

In accordance with a nineteenth aspect of exemplary embodiments of the present invention, there is a method for receiving a content, in which a content is received, which includes at least one of a scene element and a scene element set that includes the scene element, for use in scene composition, and a scene is composed by selecting at least one of the at least one of the scene element and the scene element set included in the content according to at least one of a terminal type, a user preference, and a content-serviced party.

In accordance with a twentieth aspect of exemplary embodiments of the present invention, there is an apparatus for receiving a content, in which a receiver receives a content including at least one of a scene element and a scene element set that includes the scene element, for use in scene composition, a scene composition controller selects at least one of the at least one of the scene element and the scene element set included in the content according to at least one of a terminal type, a user preference, and a content-serviced party, and a scene composer composes a scene using the selected at least one of the at least one of the scene element and the scene element set.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a flowchart illustrating a conventional operation of a terminal when it receives a LASeR data stream;

FIG. 2 is a flowchart illustrating an operation of a terminal when it receives a LASeR data stream according to an exemplary embodiment of the present invention;

FIG. 3 is a flowchart illustrating an operation of the terminal when it receives a LASeR data stream according to another exemplary embodiment of the present invention;

FIG. 4 is a flowchart illustrating an operation of the terminal when it receives a LASeR data stream according to a fourth exemplary embodiment of the present invention;

FIG. 5 is a block diagram of a transmitter according to an exemplary embodiment of the present invention;

FIG. 6 is a block diagram of a receiver according to an exemplary embodiment of the present invention;

FIGS. 7A and 7B compare the present invention with a conventional technology; and

FIG. 8 conceptually illustrates a typical mosaic service.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A description will be made of a method and apparatus for composing a scene using a LASeR content according to the type of a terminal identified by at least one of a condition, a characteristic, a capability, and a status of the terminal and occurrence of a predetermined event, or according to a change in the terminal type. The LASeR content includes at least one of a plurality of scene element sets and scene elements for use in displaying a scene according to the terminal type. The plurality of scene element sets and scene elements include at least one of scene element sets configured according to terminal types identified by display sizes or Central Processing Unit (CPU) process capabilities, the priority levels of the scene element sets, the priority level of each scene element, and the priority levels of alternative scene elements that can substitute for existing scene elements.

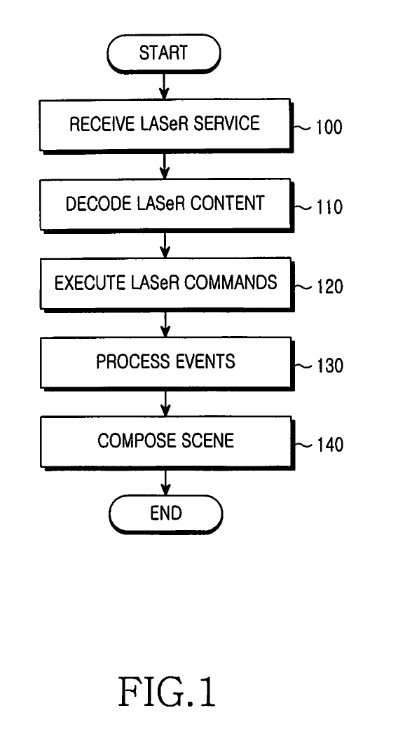

FIG. 1 is a flowchart illustrating a conventional operation of a terminal when it receives a LASeR data stream.

Referring to FIG. 1, the terminal receives a LASeR service in step 100 and decodes a LASeR content of the LASeR service in step 110. In step 120, the terminal detects LASeR commands from the decoded LASeR content and executes the LASeR commands. The receiver processes all events of the LASeR content in step 130 and displays a scene in step 140. The terminal operates based on an execution model specified by the ISO/IEC 14496-20: MPEG-4 LASeR standard. The LASeR content is expressed as a syntax written in Table 1. According to Table 1, the terminal composes a scene (<svg> . . . </svg>) described by each LASeR command (<Isru: NewScene>) and displays the scene.

TABLE 1

```
<?xml version=”1.0” encoding=”UTF-8”?>
<lsru:NewScene>
    <svg width=”480” height=”360” viewBox=”0 0 480 360”>
        ...
    </svg>
</lsru:NewScene>
```

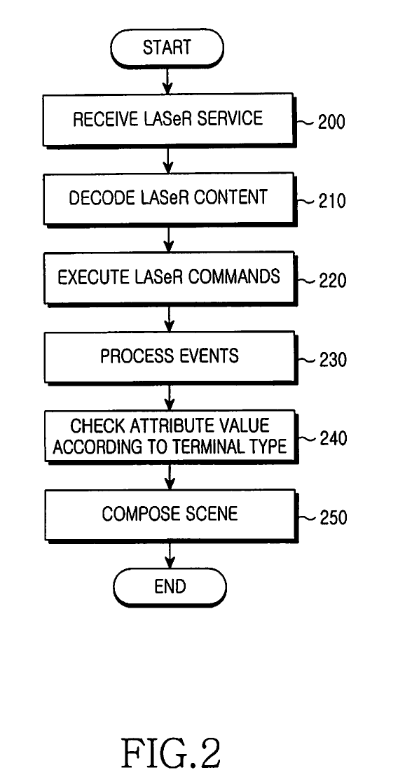

FIG. 2 is a flowchart illustrating an operation of a terminal, when it receives a LASeR data stream according to an exemplary embodiment of the present invention.

A description will be made of a method for generating new attributes (e.g. display size) that identify terminal types, defining scene element sets for the respective the terminal types, and determining whether to use each scene element set, when one scene is changed to another scene in a LASeR service in accordance with the exemplary embodiment of the present invention. An attribute refers to a property of a scene element.

Referring to FIG. 2, the terminal receives a LASeR service in step 200 and decodes a LASeR content of the LASeR service in step 210. In step 220, the terminal detects LASeR commands from the decoded LASeR content and executes the LASeR commands. The receiver processes all events of the LASeR content in step 230 and detects an attribute value according to the type of the terminal in step 240. Then in step 250 the receiver composes a scene using one of the scene element sets and the scene elements, selected according to the attribute value, and displays the scene.

A modification can be made to the above exemplary embodiment of the present invention. In the case where an attribute that identifies a terminal type is a DisplaySize attribute, the DisplaySize attribute is defined and scene element sets are configured for respective display sizes (specific conditions). Notably, a scene element set defined for a terminal with a smallest display size is used as a base scene element set for terminals with larger display sizes and enhancement scene elements are additionally defined for these terminals with larger display sizes. If three DisplaySize attribute values are defined, “SMALL”, “MEDIUM” and “LARGE”, scene elements common to all terminal groups are defined as a base scene composition set and only additional elements are described as enhancement scene elements

Table 2 below illustrates an example of attributes regarding whether DisplaySize and CPU_Power should be checked to identify the type of a terminal in LASeR header information of a LASeR scene. The LASeR header information can be checked before step 220 of FIG. 2. New attributes of a LASeR Header can be defined by extending an attribute group of the LASeR Header, like in Table 2. In Table 2, new attributes ‘DisplaySizeCheck’ and ‘CPU_PowerCheck’ are defined and their types are Boolean. In addition to ‘DisplaySizeCheck’ and ‘CPU_PowerCheck’, other scene elements that indicate terminal types such as memory size, battery consumption, bandwidth, etc. can also be defined as new attributes in the same form as the above new attributes. If the values of the new attributes ‘DisplaySizeCheck’ and ‘CPU_PowerCheck’ are ‘True’, the terminal checks its type by a display size and a CPU process rate.

```
TABLE 2
<xs:complexType name=“LASeRHeaderTypeExt”>
  <xs:complexContent>
    <xs:extension base=“ lsr:LASeRHeaderType ”>
            <attribute name=“DisplaySizeCheck” type=“boolean”
use=“optional”/>
            <attribute name=“CPU_PowerCheck” type=“boolean”
use=“optional”/>
    </xs:extension>
  </xs:complexContent>
</xs:complexType>
<element name=“LASeRHeader” type=“lsr:LASeRHeaderTypeExt”/>
```

A function for identifying a terminal type (i.e. a display size or a data process rate and capability) can be performed by additionally defining new attributes in the LASeR Header as illustrated in Table 2. However, the terminal type identification function can be implemented outside a LASeR engine. Also, a change in the terminal type can be identified by an event.

Table 3a to Table 3e are examples of the new attributes described with reference to step 240 of FIG. 2.

TABLE 3a

<g lsr:DisplaySize=”SMALL”/> ... </g>
<g lsr:DisplaySize=”MEDIUM”/> ... </g>
<g lsr:DisplaySize=”LARGE”/> ... </g>

TABLE 3b

<g lsr:DisplaySize=”CIF”/> ... </g>
<g lsr:DisplaySize=”QVGA”/> ... </g>
<g lsr:DisplaySize=”QCIF”/> ... </g>
<g lsr:DisplaySize=”VGA”/> ... </g>
<g lsr:DisplaySize=”SVGA”/> ... </g>
<g lsr:DisplaySize=”CGA”/> ... </g>
<g lsr:DisplaySize=”SXGA”/> ... </g>
<g lsr:DisplaySize=”UXGA”/> ... </g>
<g lsr:DisplaySize=”UWXGA”/> ... </g>

TABLE 3c

<!-ScreenWidth ScreenHeight -->
<g lsr:DisplaySize=”640 480”/> ... </g>
<g lsr:DisplaySize=”1024 768”/> ... </g>
<!-DiagonalLength : 3 inch -->
<g lsr:DisplaySize=”3”/> ... </g>
<!-ScreenWidth ScreenHeight DiagonalLength -->
<g lsr:DisplaySize=”1024 768 3”/> ... </g>

TABLE 3d

<!-- ScreenWidth × ScreenHeight -->
<g lsr:DisplaySize=”1024×768”/> ... </g>

TABLE 3e

<!-- Display resolution : 2⁻⁴ -->
<g lsr:DisplaySize=”4”/> ... </g>

Table 4a to Table 4e are exemplary definitions of the new attributes described in Table 3a to Table 3e. In Table 4a to Table 4e, the new attribute ‘DisplaySize’ is defined and its type is defined as ‘DisplaySizeType’. ‘DisplaySize’ can be classified into some categories of the display size group which can represent the symbolic string value as “SMALL”, “MEDIUM”, and “LARGE” or the classification can be further made into more levels. Needless to say, the attribute or its values can be named otherwise. For example, for the attribute definition, Common Intermediate Format (CIF) or Quarter Common Intermediate Format (QCIF), actual display sizes like width and length (320, 240) or (320×240), diagonal length ‘3(inch)’, or (width, length, diagonal length), or resolution, for instance, in the form of 2^{resolution} or 2^{-resolution} can be used. ‘DisplaySize’ can provide information representing specific DisplaySize groups such as ‘Cellphone’, ‘PMP’, and ‘PC’ as well as information indicating scene sizes.

While not shown, any values that represent display sizes can be used as new DisplaySize attribute values in the present invention.

In accordance with the exemplary embodiment of the present invention, the new attribute ‘DisplaySize’ has values indicating screen sizes of terminals. A terminal selects a scene element set or a scene element according to an attribute value corresponding to its type. It is obvious to those skilled in the art that the exemplary embodiment of the present invention can be modified by adding or modifying factors corresponding to the device types.

Although the new attributes and scene elements can be defined in various ways in the present invention, it can be said that attributes having the same signification are identical, despite their different definitions.

```
TABLE 4a
<attribute name=“DisplaySize” type=“DisplaySizeType” use=“optional”/>
<simpleType name=“DisplaySizeType”>
  <restriction base=“NMTOKEN”> <!-- restriction base=“string” -->
  <enumeration value=“SMALL”/>
    <enumeration value=“MEDIUM”/>
    <enumeration value=“LARGE”/>
  </restriction>
</simpleType>
```

```
TABLE 4b
<attribute name=“DisplaySize” type=“DisplaySizeType” use=“optional”/>
<simpleType name=“DisplaySizeType”>
  <restriction base=“NMTOKEN”> <!-- restriction base=“string” -->
    <enumeration value=“CIF”/>
      <enumeration value=“QVGA”/>
      <enumeration value=“QCIF”/>
      <enumeration value=“VGA”/>
      <enumeration value=“SVGA”/>
      <enumeration value=“CGA”/>
      <enumeration value=“SXGA”/>
      <enumeration value=“UXGA”/>
      <enumeration value=“UWXGA”/>
  </restriction>
</simpleType>
```

```
TABLE 4c
<attribute name=“DisplaySize” type=“DisplaySizeType” use=“optional”/>
<simpleType name=“DisplaySizeType”>
    <!-ScreenWidth ScreenHeight OR DiagonalLength OR ScreenWidth
ScreenHeight DiagonalLength -->
  <list itemType=“float”/>
</simpleType>
```

```
TABLE 4d
<attribute name=“DisplaySize” type=“resolutionType” use=“optional”/>
<simpleType name=“resolutionType”>
      <restriction base=“integer”>
        <minInclusive value=“−8”/>
        <maxInclusive value=“7”/>
      </restriction>
</simpleType>
```

```
TABLE 4e
<attribute name=“DisplaySize” type=“DisplaySizeType” use=“optional”/>
<complexType name=“DisplaySizeType”>
<complexContent>
  <union>
        <simpleType>
    <restriction base=“NMTOKEN”>
      <enumeration value=“SMALL”/>
            <enumeration value=“MEDIUM”/>
            <enumeration value=“LARGE”/>
          </restriction>
      </simpleType>
      <simpleType>
          <restriction base=“NMTOKEN”>
            <enumeration value=“CIF”/>
            <enumeration value=“QVGA”/>
            <enumeration value=“QCIF”/>
            <enumeration value=“VGA”/>
            <enumeration value=“SVGA”/>
            <enumeration value=“CGA”/>
            <enumeration value=“SXGA”/>
            <enumeration value=“UXGA”/>
            <enumeration value=“UWXGA”/>
    </restriction>
      </simpleType>
      <simpleType>
        <restriction base=“string”/>
      </simpleType>
      <simpleType>
        <restriction base=“float”/>
      </simpleType>
      <simpleType>
      <!-ScreenWidth ScreenHeight OR DiagonalLength OR
ScreenWidth ScreenHeight DiagonalLength OR Min Max -->
    <list itemType=“float”/>
      </simpleType>
      <simpleType name=“resolutionType”>
          <restriction base=“integer”>
            <minInclusive value=“−8”/>
            <maxInclusive value=“7”/>
          </restriction>
      </simpleType>
  </union>
  </complexContent>
</complexType>
```

The ‘DisplaySize’ attribute defined in Table 4a to Table 4e can be used as an attribute for all scene elements of a scene and also for container elements (A container element is an element which can have graphics elements and other container elements as child elements.) including other elements among the elements of the scene, such as ‘svg’, ‘g’, ‘defs’, ‘a’, ‘switch’, ‘Isr:selector’. Table 5a and Table 5b are examples of container elements using the defined attribute. In accordance with the exemplary embodiment of the present invention, scene element sets are defined for the respective attribute values of ‘DisplaySize’ and described within a container element ‘g’. According to the display size of a terminal, the terminal selects one of the scene element sets, composes a scene using the selected scene element set, and displays it.

After a base scene element set is configured, a required scene element set can be added according to a display size as in Table 5c. it also means a base scene element set can be included in the enhancement scene element set.

TABLE 5a

```
<switch>
  <g lsr:DisplaySize=”SMALL”> ... </g>
    <g lsr:DisplaySize=”MEDIUM”> ... </g>
    <g lsr:DisplaySize=”LARGE”> ... </g>
</switch>
```

```
TABLE 5b
<!-- Small_Size_Display -->
<g id=”Small_Size_Display” lsr:DisplaySize=”SMALL”> ... </g>
<!-- Medium_Size_Display -->
<g id=”Medium_Size_Display” lsr:DisplaySize=”MEDIUM”> ... </g>
<!-- LARGE _Size_Display -->
<g id=”Large_Size_Display” lsr:DisplaySize=”LARGE”> ... </g>
<!-- Small_Size_Display -->
<lsr:conditional ... ″>
    <lsr:Deactivate ref=″#Medium_Size_Display″/>
    <lsr:Deactivate ref=″#Large_Size_Display″/>
    <lsr:Activate ref=″#Small_Size_Display″/>
</lsr:conditional>
<!-- Medium_Size_Display -->
<lsr:conditional ... ″>
    <lsr:Deactivate ref=″#Small_Size_Display″/>
    <lsr:Deactivate ref=″#Large_Size_Display″/>
    <lsr:Activate ref=″#Medium_Size_Display″/>
</lsr:conditional>
<!-- Large_Size_Display -->
<lsr:conditional ... ″>
    <lsr:Deactivate ref=″#Small_Size_Display″/>
    <lsr:Deactivate ref=″#Medium_Size_Display″/>
    <lsr:Activate ref=″#Large_Size_Display″/>
</lsr:conditional>
```

TABLE 5c

```
<g lsr:DisplaySize=”LARGE”>
  ... scene description for Display Size : LARGE ...
    <g lsr:DisplaySize=”MEDIUM”>
    ... scene description for Display Size : MEDIUM ...
        <g lsr:DisplaySize=”SMALL”>
        ... scene description for Display Size : SMALL ...
        </g>
  </g>
</g>
```

Table 6a and Table 6b illustrate examples of defining the ‘DisplaySize’ attribute in a different manner. A LASeR attribute ‘requiredExtensions’ is defined in Scalable Vector Graphics (SVG) and used for LASeR, defines a list of required language extensions. In Table 6a and Table 6b, the definition regarding DisplaySize is referred to a reference outside a LASeR content, instead of defining it as a new LASeR attribute. In the exemplary embodiment of the present invention, the DisplaySize values can be expressed as “SMALL”, “MEDIUM” and “LARGE” or as Uniform Resource Identifiers (URIs) or namespaces like ‘urn:mpeg:mpeg4:LASeR:2005’, which are to be referred to. The URIs or name spaces used herein are mere examples. Thus, they can be replaced with other values as far as the values are used for the same purpose. The attribute values can be symbolic strings, names, numerals, or any other type.

```
TABLE 6a
<switch>
  <g requiredExtensions=”urn:mpeg:mpeg4:LASeR:2005:SMALL”> ...
  </g>
    <g requiredExtensions=”urn:mpeg:mpeg4:LASeR:2005:MEDIUM”>
... </g>
    <g requiredExtensions=”urn:mpeg:mpeg4:LASeR:2005:LARGE”>
... </g>
</switch>
```

```
TABLE 6b
<!-- Small_Size_Display -->
<g id=”Small_Size_Display”
requiredExtensions=”urn:mpeg:mpeg4:LASeR:2005:SMALL”> ... </g>
<!-- Medium_Size_Display -->
<g id=”Medium_Size_Display”
requiredExtensions=”urn:mpeg:mpeg4:LASeR:2005:MEDIUM”> ... </g>
<!-- LARGE _Size_Display -->
<g id=”Large_Size_Display”
requiredExtensions=”urn:mpeg:mpeg4:LASeR:2005:LARGE”> ... </g>
<!-- Small_Size_Display -->
<lsr:conditional ... ″>
    <lsr:Deactivate ref=″#Medium_Size_Display″/>
    <lsr:Deactivate ref=″#Large_Size_Display″/>
    <lsr:Activate ref=″#Small_Size_Display″/>
</lsr:conditional>
<!-- Medium_Size_Display -->
<lsr:conditional ... ″>
    <lsr:Deactivate ref=″#Small_Size_Display″/>
    <lsr:Deactivate ref=″#Large_Size_Display″/>
    <lsr:Activate ref=″#Medium_Size_Display″/>
</lsr:conditional>
<!-- Large_Size_Display -->
<lsr:conditional ... ″>
    <lsr:Deactivate ref=″#Small_Size_Display″/>
    <lsr:Deactivate ref=″#Medium_Size_Display″/>
    <lsr:Activate ref=″#Large_Size_Display″/>
</lsr:conditional>
```

While it has been described above that a terminal type is identified by ‘DisplaySize’, it can be identified by other attributes in the same manner. For instance, if terminal types are identified by ‘CPU’, ‘Memory’, and ‘Battery’, they can be represented as Table 7a. Table 7b is an example of definitions of the attributes defined in Table 7a.

TABLE 7a

<!- CPU -->
<g lsr:CPU=”3000”.../> ... </g>
<!- Memory -->
<g lsr:Memory=”22”.../> ... </g>
<!- Battery -->
<g lsr:Battery=”900”.../> ... </g>

TABLE 7b

<attribute name=”CPU” type=”unsingedInt” use=”optional”/>
<attribute name=”Memory” type=”unsingedInt” use=”optional”/>
<attribute name=”Battery” type=”unsignedInt” use=”optional”/>

Many types are available as the attributes, as was defined for ‘DisplaySize’. These attributes indicates minimum required values of terminal regarding the terminal types for composing the scene element set. It means same as that maximum required value of terminal types is greater than the minimum required value of the attributes. They can be absolute values, relative values, or ratios regarding terminal types. For instance, CPU process rates can be expressed in MIPS, Memory attribute values can be expressed in bytes, and Battery attribute values can be expressed in mAh, to thereby identify terminal types. MIPS stands for Million Instructions Per Second, indicating the number of commands that a CPU can process for one second. MIPS is calculated by the number of commands (IPC)×clock (MHz). For example, if the CPU of terminal A operates at 2 GHs and takes two clocks to process one command, the CPU process rate of terminal A is 2 GHz×½=1000 MIPs. Memory attribute values are expressed as powers of 2. For example, 30 MB is expressed as 2²². Then Memory attribute values can be represented as 2^{‘Memory’}.

The types of attributes can be represented or replaced with other values depending on system implementation. For example, CPU process rates can be expressed in various ways using units of CPU processing rates such as alpha, arm, arm32, hppa1.1, m68k, mips, ppc, rs6000, vax, x86, etc.

The afore-defined attributes indicating terminal types can be used together as illustrated in Table 8a or Table 8b. When CPU, Memory, and Battery are represented by use of MIPS, a power of 2 (2^{‘Memory’}), and mAh, respectively, a element with an ID of ‘A01’ can be defined as a terminal with a SMALL DisplaySize and a CPU processing rate of 3000 MIPs or greater. A element with an ID of ‘A02’ can be defined as a terminal with a SMALL DisplaySize, a CPU processing rate of 4000 MIPs or greater, a Memory of 4 MB or greater (2²²), and a Battery of 900 mAh or larger. A element with an ID of ‘A03’ can be defined as a terminal with a MEDIUM DisplaySize, a CPU processing rate of 9000 MIPs or greater, a Memory of 64 MB or higher (226), and a Battery of 900 mAh or greater. Upon receipt of a LASeR content depicted as Table 8a or Table 8b, a terminal can display a scene corresponding to one of A01, A02 and A03 according to its type.

```
TABLE 8a
<switch>
    <g id=”A01” lsr:DisplaySize=”SMALL” lsr:CPU=”3000”/> ... </g>
    <g id=”A02” lsr:DisplaySize=”SMALL” lsr:CPU=”4000”
lsr:Memory=”22” lsr:Battery=”900”/> ... </g>
    <g id=”A03” lsr:DisplaySize=”MEDIUM” lsr:CPU=”9000”
lsr:Memory=”26” lsr:Battery=”900”/> ... </g>
</switch>
```

TABLE 8b

```
<!- terminal capacity 1 -->
<g id=”A01” lsr:DisplaySize=”SMALL” lsr:CPU=”3000”/> ... </g>
<!- terminal capacity 2 -->
<g id=”A02” lsr:DisplaySize=”SMALL” lsr:CPU=”4000”
lsr:Memory=”22” lsr:Battery=”900”/> ... </g>
<!- terminal capacity 3 -->
<g id=”A03” lsr:DisplaySize=”MEDIUM” lsr:CPU=”9000”
lsr:Memory=”26” lsr:Battery=”900”/> ... </g>
<!- terminal capacity 1 -->
<lsr:conditional ... ″>
    <lsr:Deactivate ref=″#A02″/>
    <lsr:Deactivate ref=″#A03″/>
    <lsr:Activate ref=″#A01″/>
</lsr:conditional>
<!- terminal capacity 2 -->
<lsr:conditional ... ″>
    <lsr:Deactivate ref=″#A01″/>
    <lsr:Deactivate ref=″#A03″/>
    <lsr:Activate ref=″#A02″/>
</lsr:conditional>
<!- terminal capacity 3 -->
<lsr:conditional ... ″>
    <lsr:Deactivate ref=″#A01″/>
    <lsr:Deactivate ref=″#A02″/>
    <lsr:Activate ref=″#A03″/>
</lsr:conditional>
```

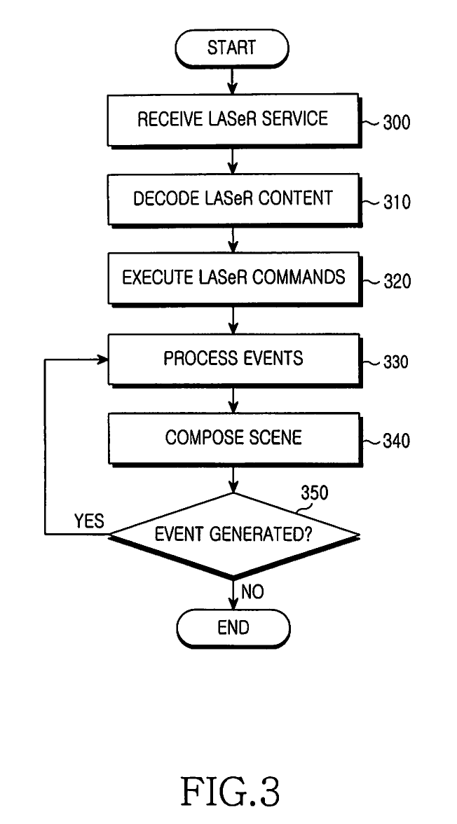

FIG. 3 is a flowchart illustrating an operation of a terminal when it receives a LASeR content according to another exemplary embodiment of the present invention.

In accordance with the second exemplary embodiment of the present invention, a change in network session management, decoding, an operation of a terminal, data input/output, or interface input/output can be defined as an event. When the LASeR engine detects an occurrence of such an event, a scene or an operation of the terminal can be changed according to the event. The second exemplary embodiment that checks for an occurrence of a new event associated with a change in a terminal type will be described with reference to FIG. 3.

Referring to FIG. 3, steps 300, 310 and 320 are identical to steps 200, 210 and 220 of FIG. 2. In step 330, the terminal processes all events of the received LASeR content and a new event related to a terminal type change according to the present invention. In step 340, the terminal composes a scene according to the processed new event and displays it. As in Table 4a, Table 4b, Table 5 and Table 7, the terminal detects an attribute value corresponding to its type and displays a scene accordingly. The new event can be detected and processed in step 330 or can occur after the scene display in step 350. An example of the new event process can be that when the LASeR engine senses an occurrence of a new event, a related script element is executed through an ev:listener(listener) element. During a LASeR service with complex scene elements, a mobile terminal can switch to a scene optimized for it, upon receipt of a user input in the second exemplary embodiment of the present invention. For example, upon receipt of a user input, the terminal can generate a new event defined in the second exemplary embodiment of the present invention.

Table 9a, Table 9b and Table 9c are examples of definitions of new events associated with changes in display size in the second exemplary embodiment of the present invention.

As noted from Table 9a, Table 9b and Table 9c, the new events can be defined using namespaces. Other namespace can be used as far as they identify the new events like Identifiers (IDs).

TABLE 9a

| Event name | Namespace | Description |
|---|---|---|
| DisplaySizeChanged | Urn:mpeg:mpeg4:laser:2008 | This event occurs |
| | | when the |
| | | display size of |
| | | terminal is changed. |

The ‘DisplaySizeChanged’ event defined in Table 9a is an example of an event that occurs when the display size of the terminal is changed. That is, an event corresponding to a changed display size is generated.

TABLE 9b

| Event name | Namespace | Description |
|---|---|---|
| DisplaySizeChanged(DisplayType) | Urn:mpeg:mpeg4: | This event occurs |
| | laser:2008 | when the display |
| | | size of terminal is |
| | | changed to a |
| | | value of |
| | | DisplaySizeType. |

The ‘DisplaySizeChanged’ event defined in Table 9b may occur when the display size of the terminal is changed to a value of DisplaySizeType. DisplaySizeType can have values, “SMALL”, “MEDIUM”, and “LARGE”. Needless to say, DisplaySizeType can be represented in other manners.

TABLE 9c

| Event name | Namespace | Description |
|---|---|---|
| DisplaySizeChanged(ScreenWidth, | Urn:mpeg:mpeg4: | This event |
| ScreeenHeight) | laser:2008 | occurs when the |
| | | display size of |
| | | terminal is |
| | | changed and |
| | | changed display |
| | | width and height |
| | | of terminal are |
| | | returned. |

The ‘DisplaySizeChanged’ event defined in Table 9c occurs when the display size of the terminal is changed, and the changed width and height of the display of the terminal are returned.

Upon the generation of an event depicted in Table 9b or Table 9c, if a specific value is returned, the returned value can be represented in various ways. For example, the returned value can be represented as CIF or QCIF, or a resolution. Also, the returned value can be represented using a display width and a display height such as (320, 240) and (320×240), the width and length of an area in which an actual scene is displayed, a diagonal length of the display, or additional length information. If the representation is made with a specific length, any length unit can be used as far as it can express a length. The representation can also be made using information indicating specific DisplaySize groups such as “Cellphone”, “PMP”, and “PC”. While not shown, any other value that can indicate a display size can be used as the return value of the DisplaySizeChanged event in the present invention.

Table 10 defines a “DisplaySizeEvent” interface using an Interface Definition Language (IDL). The IDL is a language that describes an interface and defines functions. As the IDL is designed to allow interpretation in any system and any program language, it can be interpreted in different programs. The “DisplaySizeEvent” interface can provide information about display size (contextual information) and its event type can be “DisplaySizeChanged” defined in Table 9a and Table 9c. Any attributes that represent properties of displays can be used as attributs of the “DisplaySizeEvent” interface. For example, they can be Mode, Resolution, ScreenSize, RefreshRate, ColorBitDepth, ColorPrimaries, CharacterSetCode, RenderingFormat, stereoscopic, MaximumBrightness, contrastRatio, gamma, bitPerPixel, BacklightLuminance, dotPitch, activeDisplay, etc.

TABLE 10
[IDL(Interact Definition Language) Event Definition]

```
interface LASeREvent : events::Event( ); // General IDL Definition of
LASeR events
interface DisplaySizeEvent : LASeR Event {
  readonly attribute DOMString DisplayType;
  readonly attribute unsigned long screenWidth;
  readonly attribute unsigned long screenHeight;
  // readonly attribute unsigned long clientWidth;
  // readonly attribute unsigned long clientHeight;
  // readonly attribute unsigned long diagonalLength;
}
No defined constants
Attributes
    DisplaySizeType : represents a screen size group of teminals.
    screenWidth : reprents a new or changed display or viewport width of
terminal.
    screenHeight : reprents a new or changed display or viewport legth of
terminal.
    clientWidth : reprents a new or changed viewport width.
    clientHeight : reprents a new or changed viewport length.
    diagonalLength : reprents a new or changed display or viewport
diagonal length of terminal.
```

Table 11 illustrates an example of compositing a scene using the above-defined event. Upon the generation of a ‘DisplaySizeChanged(SMALL)’ event, that is, if the display size of the terminal changes to “SMALL” or if a display size to which the terminal composes a scene is “SMALL”, an event listener senses this event and commands an event handler to execute ‘SMALL_Scene’. ‘SMALL_Scene’ is an operation for displaying a scene corresponding to the ‘DisplaySize’ attribute being SMALL.

TABLE 11

<ev:listener handler=#SMALL_Scene event=
DisplaySizeChanged(SMALL)/>
<script id=SMALL_Scene>
<g lsr:DisplaySize=SMALL/> ... </g>
</script>

As noted from Table 12 below, a change in a terminal type caused by a change in CPU process rate, available memory capacity, or remaining battery power as well as display size can be defined as an event.

TABLE 12

| Event name | Namespace | Definition |
|---|---|---|
| CPU(value) | Urn:mpeg:mpeg4:laser:2008 | This event occurs when CPU |
| | | process rate of terminal changes by |
| | | a variation A or more and returns |
| | | the new changed CPU process rate. |
| | | — |
| Memory(value) | Urn:mpeg:mpeg4:laser:2008 | This event occurs when memory |
| | | capacity of terminal changes by a |
| | | variation A or more and returns the |
| | | changed remainng memory capacity. |
| Battery(value) | Urn:mpeg:mpeg4:laser:2008 | This event occurs when battery |
| | | power of terminal changes by a |
| | | variation A or more and returns |
| | | changed remaining battery power. |

In Table 12, upon generation of each event, the returned ‘value’ can be represented as an absolute value, a relative value, or a ratio regarding a terminal type. Or the representation can be made using symbolic values to identify specific groups. ‘variation A’ in the definitions of the above events refers to a value which indicates a variation in a factor identifying a terminal type and by which occurrence of an event is recognized. Regarding the ‘CPU’ event defined in Table 12, given a variation A of 2000 for CPU, when the CPU process rate of the terminal changes from 6000 to 4000, the ‘CPU’ event occurs and the value of 4000 is returned. At the same time, the terminal can draw scenes except scenes element taking more computations than 4000 per second. These values can be represented in different manners or other values can be used depending on the various systems. In the first exemplary embodiment of the present invention, CPU, Memory, and Battery are represented in MIPS, a power of 2 (2^{Memory}), and mAh, respectively.

Table 13a and Table 13b below define an event regarding a terminal performance that identifies a terminal type using the IDL. A ‘ResourceEvent’ interface defined in Table 13a and Table 13b can provide information about a terminal performance, i.e. resource information (contextual information). An event type of the ‘ResourceEvent’ interface can be events defined in Table 12. Any attributes that can describe terminal performances, i.e. resource characteristics can be attributes of the ‘ResourceEvent’ interface.

TABLE 13a
[IDL(Interact Definition Language) Event Definition]

```
interface LASeREvent : events::Event( ); // General IDL Definition of
LASeR events
interface ResourceEvent : LASeR Event {
    readonly attribute unsigned float absoluteValue;
    readonly attribute unsigned Boolean computableAsFraction;
    readonly attribute unsigned float fraction;
    readonly attribute unsigned long resourceDelta;
}
No defined constants
Attributes
        absoluteValue : represents the current state of resources.
        computableAsFraction : indicates whether resource fraction
can be calculated using absoluteValue.
        fraction : ranges from 0 to 1 and representes the current state
of resources as a ratio.
        resourceDelta : represents a variation in resources.
```

TABLE 13b
[IDL(Interact Definition Language) Event Definition]

```
interface LASeREvent : events::Event( ); // General IDL Definition of
LASeR events
interface ResourceEvent : LASeR Event {
    readonly attribute unsigned float absoluteValue;
    readonly attribute unsigned Boolean computableAsFraction;
    readonly attribute unsigned float fraction;
    readonly attribute unsigned long resourceDelta;
    readonly attribute unsigned long resourceUnitValue;
    readonly attribute DOMString ResourceType;
}
No defined constants
Attributes
        absoluteValue : represents the current state of resources.
        computableAsFraction : indicates whether resource fraction
can be calculated using absoluteValue.
        fraction : ranges from 0 to 1 and represents the current state
of resources as a ratio.
        resourceDelta : represents a variation in resources.
        resourceUnitValue : represents a minimum unit on which a
variation in resources defined by system can be measured.
        ResourceType : identifies screen size group of terminals.
```

The capability of a terminal may vary depending on composite relations among many performance-associated factors, that is, a display size, a CPU process rate, an available memory capacity, and a remaining battery power. Table 14 is an example of defining an event from which a change in a terminal type caused by composition relations among performance-associated factors can be perceived.

When the terminal, the system, or the LASeR engine detects an occurrence of a TerminalCapabilityChanged event as the performance of the terminal changes, a scene can be composed in a different manner according to a scene descriptable criterion corresponding to the changed terminal type. A scene descriptable criterion can be the computation capability per second of the terminal or the number of scene elements that the terminal can describe. A variation caused by composite relations among the performance-associated factors can be represented through normalization. For example, when the TermialCapabilityChanged event occurs and switches to a terminal capable of 10000 calculations per second, the processing capability of the terminal is calculated. If the processing capability amounts to processing 6000 or less data calculations per second, the terminal can compose scenes except for scenes requiring 6000 or more calculations per second. In another example, scene descriptable criteria are classified from level 1 to level 10 and upon the generation of the ‘TerminalCapabilityChanged’ event, a level corresponding to a change in the terminal type is returned, for use as a scene descriptable criterion.

TABLE 14

| Event name | namespace | Definition |
|---|---|---|
| TerminalCapabilityChanged(value) | Urn:mpeg:mpeg4: | This event |
| | laser:2008 | occurs when |
| | | terminal |
| | | performance |
| | | changes by a |
| | | variaiton A or |
| | | more and a |
| | | value that can |
| | | be a scene |
| | | descriptable |
| | | criterion is |
| | | returned. |

The terminal, the system or the LASeR engine can generate the events defined in accordance with the second exemplary embodiment of the present invention according to a change in the performance of the terminal. As a result of the event generation, a return value is returned or it is only monitored to determine whether an event has been generated. While not described separately, a change in a factor identifying a terminal type can be represented as an event, as defined before.

Event triggering to another terminal in accordance with a third exemplary embodiment of the present invention will be described. An event can be used to sense an occurrence of an external event or to trigger an external event as well as to sense a terminal type change that occurs inside the terminal.

For example, when a terminal condition or a terminal type changes in terminal A, terminal B can sense the change in the type of terminal A and then provide a service according to the changed terminal type. More specifically, during a service in which terminal A and terminal B exchange scene element data, when the CPU process rate of terminal A drops from 9000 MIPS to 6000 MIPS, terminal B perceives the change and transmits or exchanges only scene elements that terminal A can process.

Also, one terminal can cause an event to another terminal receiving a service. That is, terminal B can trigger a particular event for terminal A. For instance, terminal B can trigger the ‘DisplaySizeChanged’ event to terminal A. Then terminal A recognizes that DisplaySize has been changed from the triggered event.

For this purpose, a new attribute that can identify an object to which an event is triggered is defined and added to a command related to a LASeR event, ‘SendEvent’.

TABLE 15

```
<complexType name=“sendEventTypeExt”>
  <complexContent>
    <extension base=“lsr:sendEventType”>
            <attribute name=“DeviceID” type=“anyURI”
            use=“optional”/>
    </extension>
  </complexContent>
    </complexType>
<element name=“lsr:sendEvent” type=“lsr:sendEventTypeExt”/>
```

The syntax described in Table 15 defines the new attribute added to the existing sendEvent command of LASeR. Thus sendEvent can be extended with the addition. The use of sendEvent enables a terminal to detect the generation of an external event or to trigger an event in another terminal. It should be clear that the generation of an external event can be perceived using an event defined in the second exemplary embodiment of the present invention.

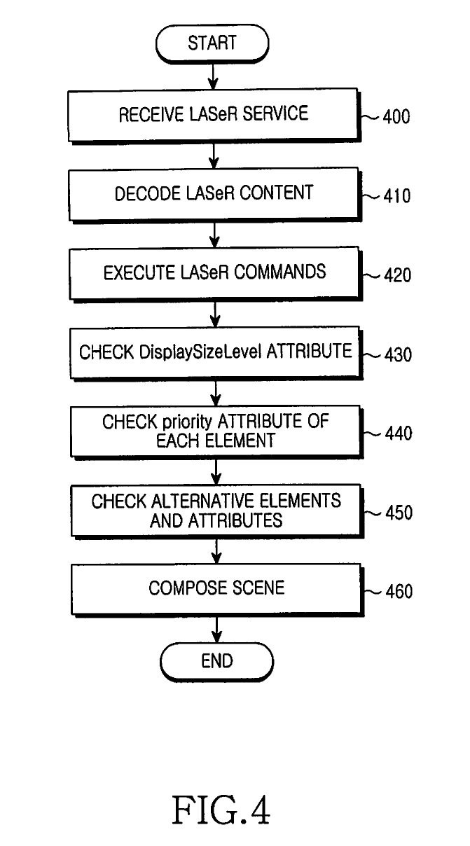

FIG. 4 is a flowchart illustrating an operation of the terminal when the terminal receives a LASeR data stream according to a fourth exemplary embodiment of the present invention.

A method for selecting a scene element optimized for the type of a terminal and displaying a scene using the selected scene element in a LASeR service according to the fourth exemplary embodiment of the present invention will be described in detail.

Referring to FIG. 4, the terminal receives a LASeR service and decodes a LASeR content of the LASeR service in step 410. In step 420, the terminal executes LASeR commands of the decoded LASeR content. Before the LASeR command execution in step 420, the terminal can check its type (i.e. display size or data process rate and capability) by a new attribute added to a LASeR Header, as illustrated in Table 2 according to the first exemplary embodiment of the present invention. The function of identifying the terminal type can be implemented outside the LASeR engine. Also, an event can be used to identify a change in the terminal type. In steps 430, 440 and 450, the terminal checks attributes according to its type. Specifically, the terminal checks a DisplaySizeLevel attribute in scene elements in step 430, checks a priority attribute in each scene element in step 440, and checks alternative elements and attributes in step 450. The terminal can select scene elements to display a scene on a screen according to its type in steps 430, 440 and 450.

Steps 430, 440 and 450 can be performed separately, or in an integrated fashion as follows. The terminal can first select a scene element set by checking the DisplaySizeLevel attribute according to its display size in step 430. In step 440, the terminal can filter out scene elements in an ascending order of priority by checking the priority attribute values (e.g. priority in scene composition) of the scene elements of the selected scene element set. If a scene element has a high priority level in scene composition but requires high levels of CPU computations, the terminal can determine if an alternative exists for the scene element and if an alternative exists, the terminal can replace the scene element with the alternative in step 450. In step 460, the terminal composes a scene with selected scene elements and displays the scene. While steps 430, 440 and 450 are performed sequentially in the illustrated in FIG. 4, they can be performed independently. Even when steps 430, 440 and 450 are performed integrally, the order of the steps can be changed.

Also, steps 430, 440 and 450 can be performed individually irrespective of the order of steps in FIG. 4. For example, they can be performed after the LASeR service reception in step 400 or after the LASeR content decoding in step 410.

Table 16a and Table 16b illustrate examples of the ‘DisplaySizeLevel’ attribute by which to select a scene element set according to the display size of the terminal. The ‘DisplaySizeLevel’ attribute can represent the priorities of scene element sets as well as scene element sets corresponding to display sizes, for the selection of a scene element set. Besides being an attribute for all scene elements, the ‘DisplaySizeLevel’ attribute can be used as an attribute of a container element including other scene elements, such as ‘g’, ‘switch’, or ‘Isr:selector’. As noted from Table 16a and Table 16b, the terminal can select a scene element set corresponding to its display size by checking the ‘DisplaySizeLevel’ attribute and display a scene using the selected element set. As illustrated in Table 16a, scene element sets can be configured separately, or a scene element set for a small display size can be included in a scene element set for a large display as illustrated in Table 16b. In Table 16a and Table 16b, a scene element with the highest ‘DisplaySizeLevel’ value is for a terminal with the smallest display size and also has the highest priority. Yet, only if a scene element set is selected in the same mechanism, the attribute can be described in any other manner and using any other criterion.

TABLE 16a

```
<lsru:NewScene>
    <svg width=“480“ height=“360“ viewBox=“0 0 480 360“>
        <g DisplaySizeLevel=“3“>
            ... terminal with the smallest display size ...
        </g>
        <g DisplaySizeLevel=“2“>
            ... terminal with a medium display size...
        </g>
        <g DisplaySizeLevel=“1“>
            ... terminal with the highest display size ...
        </g>
    </svg>
</lsru:NewScene>
```

TABLE 16b

```
<g DisplaySizeLevel=“1“>
        ... terminal with the highest display size...
        <g DisplaySizeLevel=“2“>
            ... terminal with a medium display size ...
              <g DisplaySizeLevel=“3“>
              ... terminal with the smallest display size ...
              </g>
        </g>
    </g>
```

Table 17 presents an example of the ‘DisplaySizeLevel’ attribute for use in selecting a scene element set based on the display size of a terminal. ‘priorityType’ is defined as a new type of the ‘DisplaySizeLevel’ attribute. ‘priorityType’ can be expressed as numerals like, 1, 2, 3, 4 . . . or symbolically like ‘Cellphone’, ‘PMP’, and ‘PC’ or like ‘SMALL’, ‘MEDIUM’, and ‘LARGE’. ‘priorityType’ can be represented in other manners.

TABLE 17

```
<complexType name=“priorityType“>
    <complexContent>
        <union>
            <simpleType>
                <restriction base=“unsignedInt“>
                    <maxInclusive value=“255“/>
                </restiction>
            </simpleType>
            <simpleType>
                <restriction base=“string“/>
            </simpleType>
        </union>
    </complexContent>
</complexType>
<attribute name=“DisplaySizeLevel“ type=“priorityType“
use=“optional“/>
```

Table 18 presents an example of the ‘priority’ attribute representing priority in scene composition, for example, the priority level of a scene element. The ‘priority’ attribute can be used as an attribute for container elements including many scene elements (A container element is an element which can have graphics elements and other container elements as child elements.), such as ‘g’, ‘switch’, and ‘Isr:selector’, media element such as ‘video’ and ‘image’, shape element such as ‘rect’ and ‘circle’ and all scene description element to which the ‘priority’ attribute can be applied. The type of the ‘priority’ attribute can be the above-defined ‘priorityType’ that can be numerals like, 1, 2, 3, 4 . . . or symbolic values like ‘High’, ‘Medium’, and ‘Low’ or in other manners. The criterion for determining the priority levels (i.e. Default priority levels) of elements without the ‘priority’ attribute in a scene tree may be different in terminals or LASeR contents. For instance, for a terminal or a LASeR content with a Default priority being ‘MEDIUM’, a element without the ‘priority’ attribute can take priority over a element with a ‘priority’ attribute value being ‘LOW’.

The ‘priority’ attribute can represent the priority levels of scene elements and the priority levels of scene element sets as an attribute for container elements. Also, when a scene element has a plurality of alternatives, the ‘priority’ attribute can represent the priority levels of the alternatives one of which will be selected. In this manner, the ‘priority’ attribute can be used in many cases where the priority levels of scene elements are to be represented.

Also, the ‘priority’ attribute may serve the purpose of representing user preferences or the priorities of scene elements on the part of a service provider as well as the priority levels of scene elements themselves as in the exemplary embodiments of the present invention.

TABLE 18

```
<complexType name=“priorityType“>
    <complexContent>
        <union>
            <simpleType>
                <restriction base=“unsignedInt“>
                    <maxInclusive value=“255“/>
                </restiction>
            </simpleType>
            <simpleType>
                <restriction base=“string“/>
            </simpleType>
        </union>
    </complexContent>
</complexType>
<attribute name=“priority“ type=“priorityType“ use=“optional“/>
```

Table 19 illustrates an exemplary use of the new attribute defined in Table 18. While a scene element with a high ‘priority’ attribute value is considered to have a high priority in Table 18, the ‘priority’ attribute values can be represented in many ways.

```
TABLE 19
<lsru:NewScene>
<svg>
  <g id=“A01“ priority=“3“>
    <video id=“video1“ priority=“4“ ... /> <!-highest priority in scene -->
    <image priority=“2“ ... />
    <text priority=“3“ ... </text>
  </g>
  <g id=“A02“ priority=“2“>
    <text priority=“1“> ... </text>
  </g>
  <g id=A03 priority=1/> ... </g>
</svg>
</lsru:NewScene>
```

Table 20 is an example of definitions of an ‘alternative’ element and an attribute for the ‘alternative’ element, for representing an alternative to a scene element. Since an alternative element to a scene element can have a plurality of child nodes, the alternative element can be defined as a container element that includes other elements. The type of the ‘alternative’ element can be defined by extending an ‘svg:groupType’ attribute group having basic attributes as a container element. As the ‘alternative’ element is a replacement of a basic scene element, a ‘xlink:href’ attribute can be defined in order to refer to the basic scene element. If two or more alternative element exist, one of them can be selected based on the afore-defined ‘priority’ attribute. Also, an ‘adaptation’ attribute can be used, which is a criterion for using an alternative. For example, different alternative element can be used for changes in display size and CPU process rate.

Even though elements and attributes have the same meaning, they may be named differently.

```
TABLE 20
<complexType name=“alternativeType”>
  <extension base=“svg:groupType”>
  <attributeGroup ref=“lsr:href”/> <!-- type=“anyURI” -->
  <attribute name=“priority” type=“priorityType” use=“optional”/>
  <attribute name=“adaptation” type=“adaptationType” use=“optional“/>
    </extension>
</complexType>
<complexType name=“adaptationType”>
  <complexContent>
  <union>
      <simpleType>
    <restriction base=“NMTOKEN”> <!-- restriction base=“string” -->
      <enumeration value=“DisplaySize”/>
          <enumeration value=“CPU”/>
          <enumeration value=“Memory”/>
          <enumeration value=“Battery”/>
    </restriction>
      </simpleType>
      <simpleType>
      <restriction base=“string“/>
      </simpleType>
    </union>
  </complexContent>
</complexType>
<complexType name=“priorityType“>
  <complexContent>
    <union>
      <simpleType>
        <restriction base=“unsignedInt“>
            <maxInclusive value=“255“/>
        </restiction>
      </simpleType>
      <simpleType>
        <restriction base=“string“/>
      </simpleType>
      </union>
  </complexContent>
</complexType>
<element name=“alternative” type=“alternativeType” use=“optional”/>
```

Table 21 presents an example of scene composition using ‘alternative’ elements. In the case where a ‘video’ element with an ID of ‘video 1’ is high in priority in scene composition but not proper in composing a scene optimal to a terminal type, it can be determined if there is an alternative to the ‘video’ element. As illustrated in Table 19, the ‘alternative’ element can be used as a container element with a plurality of child nodes. ‘alternative’ elements with ‘xlink:href’ attribute values being ‘video1’ can substitute for the ‘video’ element with ‘video1’. One of the alternative elements can be used on behalf of the ‘video’ element with ‘video1’. In the case where an alternative element should be used according to a terminal type change corresponding to an ‘adaptation’ attribute value, an alternative element is selected from among alternative elements with the ‘adaptation’ attribute value based on their priority levels. For example, when an alternative element is required due to a change in the display size of the terminal, the terminal selects one of alternative elements with an adaptation value being ‘DisplaySize’. The number of ‘adaptation’ attributes is not limited to one. Rather, a plurality of conditions can be used together, for example, <alternative xlink:href=“#video1” priority=“2” adaptation=“CPU” adaptation=“DisplaySize”>.

A plurality of alternative elements are available for a scene element. Only one of alternative elements with the same ‘xlink:href’ attribute value is selected.

```
TABLE 21
<lsr:NewScene>
<svg>
    <g id=“group1“ ... priority=“3”> ... </g>
    <video id=“video1” ... priority=“4”/>
    <image ... priority=“1”/>
    <video ... priority=“2”/>
    <!-- alternative for video1 -->
    <alternative xlink:href=“#video1” priority=“2” adaptation=“CPU”>
        <image .../>
        <image .../>
        <text .../>
    </alternative>
    <alternative xlink:href=“#video1” priority=“1” adaptation=“CPU”>
        <image .../>
    </alternative>
    <alternative xlink:href=“#video1” priority=“2”
    adaptation=“DisplaySize”>
        <image .../>
        <image .../>
        <text .../>
    </alternative>
    <alternative xlink:href=“#video1” priority=“1”
    adaptation=“DisplaySize”>
        <image .../>
    </alternative>
    <!-- alternative for group1 -->
    <alternative xlink:href=“#group01”>
        <image .../>
    </alternative>
</svg>
</lsr:NewScene>
```

In accordance with a fifth exemplary embodiment of the present invention, each value of the attributes identifying terminal types, including DisplaySize, CPU, Memory, Battery, DisplaySizeLevel, and Priority, is expressed as a range defined by a maximum value and a minimum value. For instance, for a scene element set requiring a minimum CPU process rate of 900 MIPS and a maximum CPU process rate of 4000 MIPS, a CPU attribute value can be expressed as in Table 22.

TABLE 22
<g lsr:CPU=‘900, 4000’>

An attribute can be separated into two new attributes, one having a maximum value and the other having a minimum value for the attribute, to identify terminal types, as in Table 23.

TABLE 23
<g lsr:CPU_MIN=”900” lsr:CPU_MAX=”4000”> ... </g>

An attribute representing a maximum value and an attribute representing a minimum value that a attribute in a LASeR header can have are defined. Table 23 defines a max ‘priority’ attribute and a min ‘priority’ attribute for a scene elements. In the same manner, for the attributes such as Display Size, CPU, Memory, Battery, DisplaySizeLevel, and Priority, a maximum attribute and a minimum attribute can separately be defined. In Table 24, the terminal detects a scene elements with a priority closest to ‘MaxPriority’ among scene elements of a LASeR content, referring to attributes of the LASeR Header.

```
TABLE 24
<complexType name=“LASeRHeaderTypeExt”>
  <complexContent>
  <extension base=“ lsr:LASeRHeaderType ”>
      <attribute name=“MaxPriority” type=“unsingedInt”
      use=“optional”/>
      <attribute name=“MinPriority” type=“ unsingedInt ”
      use=“optional”/>
  </extension>
  </complexContent>
</complexType>
<element name=“LASeRHeader” type=“lsr:LASeRHeaderTypeExt”/>
```

Table 25 below lists scene elements used in exemplary embodiments of the present invention. The new attributes ‘DisplaySize’, ‘CPU’, ‘Memory’, ‘Battery’, ‘DisplaySizeLevel’ can be used for scene elements. They can be used as attributes of all scene elements, especially container elements. The ‘priority’ attribute can be used for all scene elements forming a LASeR content.

TABLE 25

| Element name | Attributes |
|---|---|
| a | audio-level color color-rendering display display-align |
| | externalResourcesRequired fill fill-opacity fill-rule nav-right |
| | nav-next nav-up nav-up-right nav-up-left nav-prev nav-down |
| | nav-down-right nav-down-left nav-left focusable font-family |
| | font-size font-style font-variant font-weight image-rendering |
| | line-increment lsr:rotation lsr:scale lsr:translation pointer- |
| | events requiredExtensions requiredFeatures requiredFormats |
| | shape-rendering solid-color solid-opacity stop-color stop- |
| | opacity stroke stroke-dasharray stroke-dashoffset stroke- |
| | linecap stroke-linejoin stroke-miterlimit stroke-opacity stroke- |
| | width systemLanguage target text-anchor text-rendering |
| | transform vector-effect viewport-fill viewport-fill-opacity |
| | visibility xlink:actuate xlink:arcrole xlink:href xlink:role |
| | xlink:show xlink:title xlink:type DisplaySize CPU Memory Battery |
| | DiplaySizeLevel priority |
| animate | accumulate additive attributeName begin by calcMode class |
| | dur enabled end fill from id keySplines keyTimes max min |
| | repeatCount repeatDur restart to values xlink:actuate |
| | xlink:arcrole xlink:href xlink:role xlink:show xlink:title |
| | xlink:type xml:base xml:lang xml:space priority |
| alternative | xlink:href priority |
| animateColor | accumulate additive attributeName begin by calcMode class |
| | dur enabled end fill from id keySplines keyTimes max min |
| | repeatCount repeatDur restart to values xlink:actuate |
| | xlink:arcrole xlink:href xlink:role xlink:show xlink:title |
| | xlink:type xml:base xml:lang xml:space priority |
| animateMotion | accumulate additive attributeName begin by calcMode class |
| | dur enabled end fill from id keyPoints keySplines keyTimes |
| | max min path repeatCount repeatDur restart rotate to values |
| | xlink:actuate xlink:arcrole xlink:href xlink:role xlink:show |
| | xlink:title xlink:type xml:base xml:lang xml:space priority |
| lsr:animateScroll | id class xml:base xml:lang xml:space xlink:href xlink:title |
| | xlink:type xlink:role xlink:arcrole xlink:actuate xlink:show by |
| | from to delayAtStart delayAtEnd speed direction begin dur end fill restart |
| | repeatCount repeatDur priority |
| animateTransform | accumulate additive attributeName begin by calcMode class |
| | dur enabled end fill from id keySplines keyTimes max min |
| | repeatCount repeatDur restart to type values xlink:actuate |
| | xlink:arcrole xlink:href xlink:role xlink:show xlink:title |
| | xlink:type xml:base xml:lang xml:space priority |
| animation | id class xml:base xml:lang xml:space requiredFeatures |
| | requiredExtensions systemLanguage requiredFormats |
| | requiredFonts audio-level display image-rendering pointer- |
| | events shape-rendering text-rendering viewport-fill viewport- |
| | fill-opacity visibility lsr:rotation lsr:scale lsr:translation |
| | transform xlink:href xlink:title xlink:type xlink:role |
| | xlink:arcrole xlink:actuate xlink:show nav-right nav-next nav- |
| | up nav-up-right nav-up-left nav-prev nav-down nav-down- |
| | right nav-down-left nav-left focusable fill focushiglight width |
| | height x y externalResourcesRequired begin end dur min max |
| | restart repeatCount repeatDur syncBehavior syncTolerance |
| | syncMaster pereserveAspectRatio type lsr:syncReference |
| | lsr:clipBegin lsr:clipEnd initialVisibility priority |
| audio | audio-level begin class dur end externalResourcesRequired id |
| | lsr:syncReference repeatCount repeatDur requiredExtensions |
| | requiredFeatures requiredFormats syncBehavior syncTolerance |
| | systemLanguage type xlink:actuate xlink:arcrole xlink:href |
| | xlink:role xlink:show xlink:title xlink:type xml:base xml:lang |
| | xml:space type priority |
| circle | audio-level class color color-rendering cx cy display display- |
| | align fill fill-opacity fill-rule nav-right nav-next nav-up nav- |
| | up-right nav-up-left nav-prev nav-down nav-down-right nav- |
| | down-left nav-left focusable font-family font-size font-style |
| | font-weight font-variant id image-rendering line-increment |
| | lsr:rotation lsr:scale lsr:translation pointer-events r |
| | requiredExtensions requiredFeatures requiredFormats shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | systemLanguage text-anchor text-rendering transform vector- |
| | effect viewport-fill viewport-fill-opacity visibility xml:base |
| | xml:lang xml:space priority |
| lsr:conditional | id class begin enabled externalResourcesRequired xlink:href |
| | xlink:title xlink:type xlink:role xlink:arcrole xlink:actuate |
| | xlink:show xml:base xml:lang xml:space priority |
| lsr:cursorManager | id class xml:base xml:lang xml:space xlink:href xlink:title |
| | xlink:type xlink:role xlink:arcrole xlink:actuate xlink:show x y |
| | priority |
| defs | audio-level class color color-rendering display display-align |
| | fill fill-opacity fill-rule font-family font-size font-style font- |
| | variant font-weight id image-rendering line-increment pointer- |
| | events shape-rendering solid-color solid-opacity stop-color |
| | stop-opacity stroke stroke-dasharray stroke-dashoffset stroke- |
| | linecap stroke-linejoin stroke-miterlimit stroke-opacity stroke- |
| | width text-anchor text-rendering vector-effect viewport-fill |
| | viewport-fill-opacity visibility xml:base xml:lang xml:space |
| | DisplaySize CPU Memory Battery DiplaySizeLevel |
| desc | class id xml:base xml:lang xml:space priority |
| ellipse | audio-level class color color-rendering cx cy display display- |
| | align fill fill-opacity fill-rule nav-right nav-next nav-up nav- |
| | up-right nav-up-left nav-prev nav-down nav-down-right nav- |
| | down-left nav-left focusable font-family font-size font-style |
| | font-variant font-weight id image-rendering line-increment |
| | lsr:rotation lsr:scale lsr:translation pointer-events |
| | requiredExtensions requiredFeatures requiredFormats rx ry |
| | shape-rendering solid-color solid-opacity stop-color stop- |
| | opacity stroke stroke-dasharray stroke-dashoffset stroke- |
| | linecap stroke-linejoin stroke-miterlimit stroke-opacity stroke- |
| | width systemLanguage text-anchor text-rendering transform |
| | vector-effect viewport-fill viewport-fill-opacity visibility |
| | xml:base xml:lang xml:space priority |
| font | id class xml:base xml:lang xml:space |
| | externalResourcesRequired horiz-adv-x horiz-origin-x priority |
| font-face | id class xml:base xml:lang xml:space accent-height alphabetic |
| | ascent bbox cap-height descent externalResourcesRequired |
| | font-family font-stretch font-style font-variant font-weight |
| | hanging ideographic mathematical overline-position overline- |
| | thickness panose-1 slope stemh stemv strikethrough-position |
| | strikethrough-thickness underline-position underline-thickness |
| | unicode-range units-per-em widths x-height priority |
| font-face-src | id class xml:base xml:lang xml:space priority |
| font-face-uri | id class xml:base xml:lang xml:space |
| | externalResourcesRequired xlink:href xlink:title xlink:type |
| | xlink:role xlink:arcrole xlink:actuate xlink:show priority |
| foreignObject | audio-level class color color-rendering display display-align |
| | externalResourcesRequired fill fill-opacity fill-rule nav-right |
| | nav-next nav-up nav-up-right nav-up-left nav-prev nav-down |
| | nav-down-right nav-down-left nav-left focusable font-family |
| | font-size font-style font-variant font-weight height id image- |
| | rendering line-increment pointer-events requiredExtensions |
| | requiredFeatures requiredFormats shape-rendering solid-color |
| | solid-opacity stop-color stop-opacity stroke stroke-dasharray |
| | stroke-dashoffset stroke-linecap stroke-linejoin stroke- |
| | miterlimit stroke-opacity stroke-width systemLanguage text- |
| | anchor text-rendering vector-effect viewport-fill viewport-fill- |
| | opacity visibility width x xml:base xml:lang xml:space y |
| | priority |
| g | id class xml:base xml:lang xml:space audio-level color color- |
| | rendering display display-align fill fill-opacity fill-rule font- |
| | family font-size font-style text-decoration font-weight font- |
| | variant image-rendering line-increment pointer-events shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | text-anchor text-rendering viewport-fill viewport-fill-opacity |
| | vector-effect visibility lsr:rotation lsr:scale lsr:translation |
| | transform requiredFeatures requiredExtensions |
| | systemLanguage requiredFormats requiredFonts nav-right nav- |
| | next nav-up nav-up-right nav-up-left nav-prev nav-down nav- |
| | down-right nav-down-left nav-left focusable focusHighlight |
| | externalResourcesRequired DisplaySize CPU Memory Battery |
| | DiplaySizeLevel priority |
| glyph | id class xml:base xml:lang xml:space arabic-form d glyph- |
| | name horiz-adv-x lang unicode externalResourceRequired |
| | xlink:href xlink:title xlink:type xlink:role xlink:arcrole |
| | xlink:actuate xlink:show priority |
| hkern | id class xml:base xml:lang xml:space g1 g2 k u1 u2 priority |
| image | class display externalResourcesRequired nav-right nav-next |
| | nav-up nav-up-right nav-up-left nav-prev nav-down nav-down- |
| | right nav-down-left nav-left focusable height id lsr:rotation |
| | lsr:scale lsr:translation opacity pointer-events |
| | requiredExtensions requiredFeatures requiredFormats |
| | systemLanguage transform transformBehavior type visibility |
| | width x xlink:actuate xlink:arcrole xlink:href xlink:role |
| | xlink:show xlink:title xlink:type xml:base xml:lang xml:space |
| | y type preserveAspectRatio viewport-fill viewport-fill-opacity |
| | priority |
| line | audio-level class color color-rendering display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight id image-rendering line-increment lsr:rotation |
| | lsr:scale lsr:translation pointer-events requiredExtensions |
| | requiredFeatures requiredFormats shape-rendering solid-color |
| | solid-opacity stop-color stop-opacity stroke stroke-dasharray |
| | stroke-dashoffset stroke-linecap stroke-linejoin stroke- |
| | miterlimit stroke-opacity stroke-width systemLanguage text- |
| | anchor text-rendering transform vector-effect viewport-fill |
| | viewport-fill-opacity visibility x1 x2 xml:base xml:lang |
| | xml:space y1 y2 priority |
| linearGradient | audio-level class color color-rendering display display-align |
| | fill fill-opacity fill-rule font-family font-size font-style font- |
| | variant font-weight gradient-units id image-rendering line- |
| | increment pointer-events shape-rendering solid-color solid- |
| | opacity stop-color stop-opacity stroke stroke-dasharray stroke- |
| | dashoffset stroke-linecap stroke-linejoin stroke-miterlimit |
| | stroke-opacity stroke-width text-anchor text-rendering vector- |
| | effect viewport-fill viewport-fill-opacity visibility x1 x2 |
| | xml:base xml:lang xml:space y1 y2 priority |
| ev:listener | id enabled event handler observer phase propagate |
| | defaultAction target priority |
| metadata | class id xml:base xml:lang xml:space priority |
| missing-glyph | id class xml:base xml:lang xml:space d horiz-adv x priority |
| mpath | class id xlink:actuate xlink:arcrole xlink:href xlink:role |
| | xlink:show xlink:title xlink:type xml:base xml:lang xml:space |
| | priority |
| path | audio-level class color color-rendering d display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight id image-rendering line-increment lsr:rotation |
| | lsr:scale lsr:translation pathLength pointer-events |
| | requiredExtensions requiredFeatures requiredFormats shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | systemLanguage text-anchor text-rendering transform vector- |
| | effect viewport-fill viewport-fill-opacity visibility xml:base |
| | xml:lang xml:space priority |
| polygon | audio-level class color color-rendering display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight id image-rendering line-increment lsr:rotation |
| | lsr:scale lsr:translation pointer-events points |
| | requiredExtensions requiredFeatures requiredFormats shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | systemLanguage text-anchor text-rendering transform vector- |
| | effect viewport-fill viewport-fill-opacity visibility xml:base |
| | xml:lang xml:space priority |
| polyline | audio-level class color color-rendering display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight id image-rendering line-increment lsr:rotation |
| | lsr:scale lsr:translation pointer-events points |
| | requiredExtensions requiredFeatures requiredFormats shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | systemLanguage text-anchor text-rendering transform vector- |
| | effect viewport-fill viewport-fill-opacity visibility xml:base |
| | xml:lang xml:space priority |
| radialGradient | audio-level class color color-rendering cx cy display display- |
| | align fill fill-opacity fill-rule font-family font-size font-style |
| | font-variant font-weight gradient-units id image-rendering line- |
| | increment pointer-events r shape-rendering solid-color solid- |
| | opacity stop-color stop-opacity stroke stroke-dasharray stroke- |
| | dashoffset stroke-linecap stroke-linejoin stroke-miterlimit |
| | stroke-opacity stroke-width text-anchor text-rendering vector- |
| | effect viewport-fill viewport-fill-opacity visibility xml:base |
| | xml:lang xml:space priority |
| rect | audio-level class color color-rendering display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight height id image-rendering line-increment |
| | lsr:rotation lsr:scale lsr:translation pointer-events |
| | requiredExtensions requiredFeatures requiredFormats rx ry |
| | shape-rendering solid-color solid-opacity stop-color stop- |
| | opacity stroke stroke-dasharray stroke-dashoffset stroke- |
| | linecap stroke-linejoin stroke-miterlimit stroke-opacity stroke- |
| | width systemLanguage text-anchor text-rendering transform |
| | vector-effect viewport-fill viewport-fill-opacity visibility width |
| | x xml:base xml:lang xml:space y priority |
| lsr:rectClip | id class xml:base xml:lang xml:space audio-level color color- |
| | rendering display display-align fill fill-opacity fill-rule font- |
| | family font-size font-style text-decoration font-weight font- |
| | variant image-rendering line-increment pointer-events shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | text-anchor text-rendering viewport-fill viewport-fill-opacity |
| | vector-effect visibility lsr:rotation lsr:scale lsr:translation |
| | transform requiredFeatures requiredExtensions |
| | systemLanguage requiredFormats requiredFonts nav-right nav- |
| | next nav-up nav-up-right nav-up-left nav-prev nav-down nav- |
| | down-right nav-down-left nav-left focusable focusHighlight |
| | externalResourcesRequired size width height x y DisplaySize |
| | CPU Memory Battery DiplaySizeLevel priority |
| script | begin class enabled externalResourcesRequired id type |
| | xlink:actuate xlink:arcrole xlink:href xlink:role xlink:show |
| | xlink:title xlink:type xml:base xml:lang xml:space type priority |
| lsr:selector | id class xml:base xml:lang xml:space audio-level color color- |
| | rendering display display-align fill fill-opacity fill-rule font- |
| | family font-size font-style text-decoration font-weight font- |
| | variant image-rendering line-increment pointer-events shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | text-anchor text-rendering viewport-fill viewport-fill-opacity |
| | vector-effect visibility lsr:rotation lsr:scale lsr:translation |
| | transform requiredFeatures requiredExtensions |
| | systemLanguage requiredFormats requiredFonts nav-right nav- |
| | next nav-up nav-up-right nav-up-left nav-prev nav-down nav- |
| | down-right nav-down-left nav-left focusable focusHighlight |
| | externalResourcesRequired choice DisplaySize CPU Memory |
| | Battery DiplaySizeLevel priority |
| set | attributeName begin class dur enabled end fill id max min |
| | repeatCount repeatDur restart to xlink:actuate xlink:arcrole |
| | xlink:href xlink:role xlink:show xlink:title xlink:type xml:base |
| | xml:lang xml:space priority |
| lsr:setScroll | id class xml:base xml:lang xml:space begin increment to |
| | direction xlink:actuate xlink:arcrole xlink:href xlink:role |
| | xlink:show xlink:title xlink:type priority |
| lsr:simpleLayout | id class xml:base xml:lang xml:space audio-level color color- |
| | rendering display display-align fill fill-opacity fill-rule font- |
| | family font-size font-style text-decoration font-weight font- |
| | variant image-rendering line-increment pointer-events shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | text-anchor text-rendering viewport-fill viewport-fill-opacity |
| | vector-effect visibility lsr:rotation lsr:scale lsr:translation |
| | transform requiredFeatures requiredExtensions |
| | systemLanguage requiredFormats requiredFonts nav-right nav- |
| | next nav-up nav-up-right nav-up-left nav-prev nav-down nav- |
| | down-right nav-down-left nav-left focusable focusHighlight |
| | externalResourcesRequired size DisplaySize CPU Memory |
| | Battery DiplaySizeLevel priority |
| stop | audio-level class color color-rendering display display-align |
| | fill fill-opacity fill-rule font-family font-size font-style font- |
| | variant font-weight id image-rendering line-increment offset |
| | pointer-events shape-rendering solid-color solid-opacity stop- |
| | color stop-opacity stroke stroke-dasharray stroke-dashoffset |
| | stroke-linecap stroke-linejoin stroke-miterlimit stroke-opacity |
| | stroke-width text-anchor text-rendering vector-effect viewport- |
| | fill viewport-fill-opacity visibility xml:base xml:lang |
| | xml:space priority |
| streamSource | id class xml:base xml:lang xml:space sources sourceIndex |
| | width height mode priority |
| svg | audio-level baseProfile class color color-rendering |
| | contentScriptType display display-align |
| | externalResourcesRequired fill fill-opacity fill-rule font-family |
| | font-size font-style font-variant font-weight height id image- |
| | rendering line-increment playbackOrder pointer-events |
| | preserveAspectRatio shape-rendering snapshotTime solid- |
| | color solid-opacity stop-color stop-opacity stroke stroke- |
| | dasharray stroke-dashoffset stroke-linecap stroke-linejoin |
| | stroke-miterlimit stroke-opacity stroke-width |
| | syncBehaviorDefault syncToleranceDefault text-anchor text- |
| | rendering timeLineBegin vector-effect version viewBox |
| | viewport-fill viewport-fill-opacity visibility width xml:base |
| | xml:lang xml:space zoomAndPan DisplaySize CPU Memory |
| | Battery DiplaySizeLevel priority |
| switch | audio-level class color color-rendering display display-align |
| | externalResourcesRequired fill fill-opacity fill-rule nav-right |
| | nav-next nav-up nav-up-right nav-up-left nav-prev nav-down |
| | nav-down-right nav-down-left nav-left focusable font-family |
| | font-size font-style font-variant font-weight id image-rendering |
| | line-increment lsr:rotation lsr:scale lsr:translation pointer- |
| | events requiredExtensions requiredFeatures requiredFormats |
| | shape-rendering solid-color solid-opacity stop-color stop- |
| | opacity stroke stroke-dasharray stroke-dashoffset stroke- |
| | linecap stroke-linejoin stroke-miterlimit stroke-opacity stroke- |
| | width systemLanguage text-anchor text-rendering transform |
| | vector-effect viewport-fill viewport-fill-opacity visibility |
| | xml:base xml:lang xml:space DisplaySize CPU Memory |
| | Battery DiplaySizeLevel priority |
| text | audio-level color color-rendering display display-align editable |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight image-rendering line-increment lsr:rotation |
| | lsr:scale lsr:translation pointer-events requiredExtensions |
| | requiredFeatures requiredFormats rotate shape-rendering solid- |
| | color solid-opacity stop-color stop-opacity stroke stroke- |
| | dasharray stroke-dashoffset stroke-linecap stroke-linejoin |
| | stroke-miterlimit stroke-opacity stroke-width systemLanguage |
| | text-anchor text-rendering transform vector-effect viewport-fill |
| | viewport-fill-opacity visibility x y priority |
| title | class id xml:base xml:lang xml:space priority |
| tspan | audio-level class color color-rendering display display-align |
| | fill fill-opacity fill-rule nav-right nav-next nav-up nav-up-right |
| | nav-up-left nav-prev nav-down nav-down-right nav-down-left |
| | nav-left focusable font-family font-size font-style font-variant |
| | font-weight id image-rendering line-increment pointer-events |
| | requiredExtensions requiredFeatures requiredFormats shape- |
| | rendering solid-color solid-opacity stop-color stop-opacity |
| | stroke stroke-dasharray stroke-dashoffset stroke-linecap |
| | stroke-linejoin stroke-miterlimit stroke-opacity stroke-width |
| | systemLanguage text-anchor text-rendering vector-effect |
| | viewport-fill viewport-fill-opacity visibility xml:base xml:lang |
| | xml:space priority |
| use | audio-level class color color-rendering display display-align |
| | externalResourcesRequired fill fill-opacity fill-rule nav-right |
| | nav-next nav-up nav-up-right nav-up-left nav-prev nav-down |
| | nav-down-right nav-down-left nav-left focusable font-family |
| | font-size font-style font-variant font-weight id image-rendering |
| | line-increment lsr:rotation lsr:scale lsr:translation overflow |
| | pointer-events requiredExtensions requiredFeatures |
| | requiredFormats shape-rendering solid-color solid-opacity |
| | stop-color stop-opacity stroke stroke-dasharray stroke- |
| | dashoffset stroke-linecap stroke-linejoin stroke-miterlimit |
| | stroke-opacity stroke-width systemLanguage text-anchor text- |
| | rendering transform vector-effect viewport-fill viewport-fill- |
| | opacity visibility x xlink:actuate xlink:arcrole xlink:href |
| | xlink:role xlink:show xlink:title xlink:type xml:base xml:lang |
| | xml:space y priority |
| updates | externalResourcesRequired requiredExtensions |
| | requiredFeatures requiredFormats systemLanguage |
| | xlink:actuate xlink:arcrole xlink:href xlink:role xlink:show |
| | xlink:title xlink:type begin class dur end id lsr:syncReference |
| | repeatCount repeatDur syncBehavior syncTolerance type |
| | xml:base xml:lang xml:space clipBegin clipEnd security flow |
| | priority |
| Video | audio-level begin display dur end externalResourcesRequired |
| | fullscreen nav-right nav-next nav-up nav-up-right nav-up-left |
| | nav-prev nav-down nav-down-right nav-down-left nav-left |
| | focusable height lsr:rotation lsr:scale lsr:syncReference |
| | lsr:translation overlay pointer-events repeatCount repeatDur |
| | requiredExtensions requiredFeatures requiredFormats |
| | syncBehavior syncTolerance systemLanguage transform |
| | transformBehavior type visibility width x xlink:actuate |
| | xlink:arcrole xlink:href xlink:role xlink:show xlink:title |
| | xlink:type y type priority |

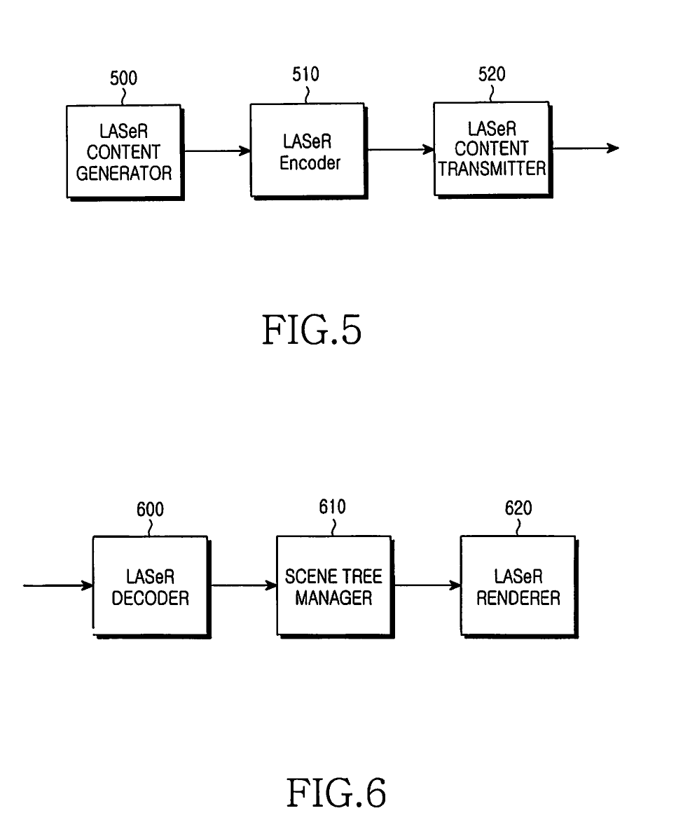

FIG. 5 is a block diagram of a transmitter according to an exemplary embodiment of the present invention.

Referring to FIG. 5, a LASeR content generator 500 generates scene elements including scene elements and attributes that identify terminal types according to the exemplary embodiments of the present invention. The LASeR content generator 500 also generates a content about using an event or an operation associated with occurrence of an event during generating the scene elements. The LASeR content generator 500 provides the generated LASeR content to a LASeR encoder 510. The LASeR encoder 510 encodes the LASeR content, and a LASeR content transmitter 520 transmits the encoded LASeR content.

FIG. 6 is a block diagram of a receiver according to an exemplary embodiment of the present invention.

Referring to FIG. 5, upon receipt of a LASeR content from the transmitter, a LASeR decoder 600 decodes the LASeR content. A LASeR scene tree manager 610 detects decoded LASeR contents including scene elements and attributes that identify terminal types according to the exemplary embodiments of the present invention. The LASeR scene tree manager 610 also detects a content about using an event or an operation associated with occurrence of an event. A LASeR scene tree manager 610 functions to control scene composition. A LASeR renderer 620 composes a scene using the detected information and displays it on a screen of the terminal.

In general, one LASeR service provides one scene element set. When a scene is updated or a new scene is composed, there are no factors that take into account terminal types. However, in the case where terminals with different display sizes are connected over an integrated network, a complex scene is not suitable for a mobile phone. If a scene is optimized for the screen size of a PC, a mobile phone may not discriminate scene elements and interpret text. Therefore, it is necessary to configure a plurality of scene element sets according to terminal types, for example, display sizes and select a scene element set for each terminal.

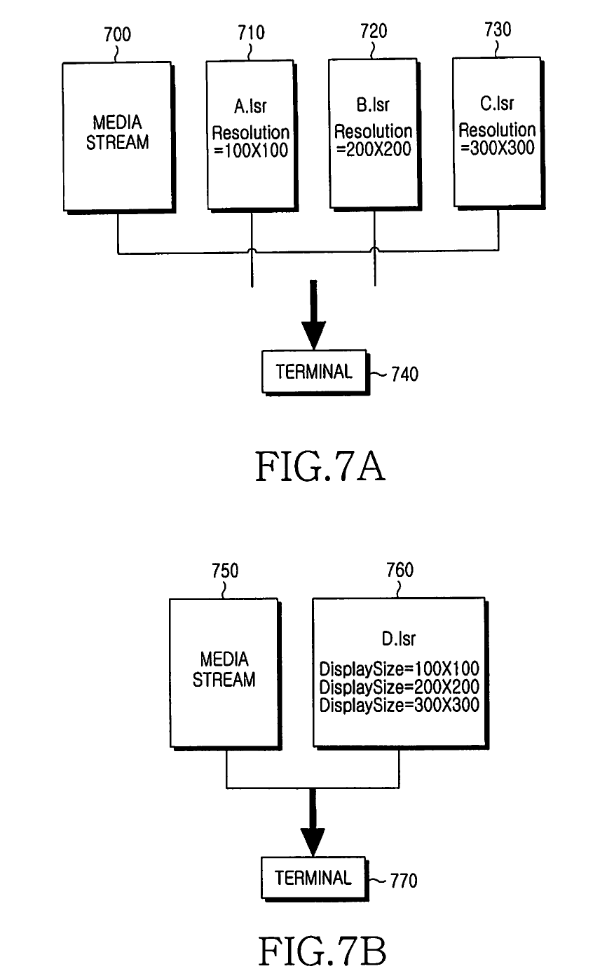

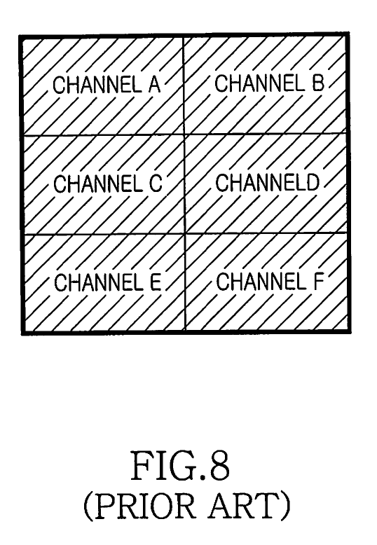

FIGS. 7A and 7B compare the present invention with a conventional technology.

With reference to FIGS. 7A and 7B, a conventional method for generating a plurality of LASeR files (or contents) for as many displays will be compared with a method for generating a plurality of scene elements in one LASeR file (or content) according to the present invention.

Referring to FIG. 7A, reference numerals 710, 720 and 730 denote LASeR files (or contents) having scene element sets optimized for terminals. The LASeR files 710, 720 and 730 can be transmitted along with a media stream (file) to a terminal 740. However, the terminal 740 has no way to know which LASeR file (or content) to decode among the four LASeR files 700 to 730. The terminal 740 does not know that the three LASeR files 710, 720 and 730 carry scene element sets optimized according to terminal types. Moreover, the same command should be included in the three LASeR files 710, 720 and 730, which is inefficient in terms of transmission.

Referring to FIG. 7B, on the other hand, a media stream (or file) 750 and a LASeR file (or content) 760 with a plurality of scene element sets defined with attributes and events are transmitted to a terminal 770 in the present invention. The terminal 770 can select an optimal scene element set and scene element based on pre-defined attributes and events according to the performance and characteristic of the terminal 770. Since the scene elements share information such as commands, the present invention is more advantageous in transmission efficiency.

While it has been described above that terminal types are identified by DisplaySize, CPU, Memory or Battery in the exemplary embodiment of the present invention, other factors such as terminal characteristics, terminal capability, status, and condition can be used in identifying the terminal types so as to compose an optimal scene for each terminal.

For example, the factors may include encoding, decoding, audio, Graphics, image, SceneGraph, Transport, Video, Buffersize, Bit-rate, VertaxRate, and FillRate. These characteristics can be used individually or collectively as a CODEC performance.

Also, the factors may include display mode (Mode), resolution (Resolution), screen size (ScreenSize), refresh rate (RefreshRate), color information (e.g. ColorBitDepth, ColorPrimaries, CharacterSetCode, etc.), rendering type (RenderingFormat), stereoscopic display (stereoscopic), maximum brightness (MaximumBrightness), contrast (contrastRatio), gamma (gamma), number of bits per pixel (bitPerPixel), backlight luminance (BacklightLuminance), dot pitch (dotPitch), and display information for a terminal with a plurality of displays (activeDisplay). These characteristics can be used individually or collectively as a display performance.

The factors may include sampling frequency (SamplingFrequency), number of bits per sample (bitsPerSample), low frequency (lowFrequency), high frequency (highFrequency), signal to noise ratio (SignalNoiseRatio), power (power), number of channels (numChannels), and silence suppression (silenceSuppression). These characteristics can be used individually or collectively as an audio performance.

The factors may include text string (StringInput), key input (KeyInput), microphone (Microphone), mouse (Mouse), trackball (Trackball), pen (Pen), tablet (Tablet), joystick, and controller. These characteristics can be used individually or collectively as a UserInteractionInput performance.

The factors may include average power consumption (averageAmpereConsumption), remaining battery capacity (BatteryCapacityRemaining), remaining battery time (BatteryTimeRemaining), and use or non-use of battery (RuningOnBatteries). These characteristics can be used individually or collectively as a battery performance.

The factors may include input transfer rate (InputTransferRate), output transfer rate (OutputTransperRate), size (Size), readable (Readable), and writable (Writable). These characteristics can be used individually or collectively as a storage performance.

The factors may include a bus width per bit (busWidth), bus transfer speed (TransferSpeed), maximum number of devices supported by a bus (maxDevice), and number of devices supported by a bus (numDevice). These characteristics can be used individually or collectively as a DataIOs performance.

Also, three-dimensional (3D) data process performance and network-related performance can also be utilized in composing optimal scenes for terminals.

The exemplary embodiments of the present invention can also be implemented in composing an optimal or adapted scene according to user preferences and contents-serviced targets as well as terminal types that are identified by characteristics, performance, status or conditions.

As is apparent from the above description, the present invention advantageously enables a terminal to compose an optimal scene according to its type by identifying its type by display size, CPU process rate, memory capacity, or battery power and display the scene.

When the terminal type is changed, the terminal can also compose a scene optimized to the changed terminal size and display it.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for transmitting content, comprising:
generating content including at least one of a scene element and a scene element set that includes the scene element, for use in scene composition according to at least one of a terminal type, a user preference, and a content-serviced party;
encoding the content; and
transmitting the encoded content.

2. The method of claim 1, wherein the terminal type is classified according to at least one of a characteristic, capability, status, and condition of a terminal.

3. The method of claim 2, wherein the terminal type is classified according to at least one of a display size, a Central Processing Unit (CPU) processing capability, a remaining battery power, and an available memory capacity of the terminal.

4. An apparatus for transmitting content, comprising:
a contents generator for generating content including at least one of a scene element and a scene element set that includes the scene element, for use in scene composition according to at least one of a terminal type, a user preference, and a content-serviced party;
an encoder for encoding the content; and
a transmitter for transmitting the encoded content.

5. The apparatus of claim 4, wherein the terminal type is classified according to at least one of a characteristic, capability, status, and condition of a terminal.

6. The apparatus of claim 5, wherein the terminal type is classified according to at least one of a display size, a Central Processing Unit (CPU) processing capability, a remaining battery power, and an available memory capacity of the terminal.

7. A method for receiving content, comprising:
receiving content including at least one of a scene element and a scene element set that includes the scene element, for use in scene composition according to at least one of a terminal type, a user preference, and a content-serviced party; and
composing a scene by selecting at least one of the at least one of the scene element and the scene element set included in the content according to the at least one of the terminal type, the user preference, and the content-serviced party.

8. The method of claim 7, wherein the terminal type is classified according to at least one of a characteristic, capability, status, and condition of a terminal.

9. The method of claim 8, wherein the terminal type is classified according to at least one of a display size, a Central Processing Unit (CPU) processing capability, a remaining battery power, and an available memory capacity of the terminal.

10. An apparatus for receiving content, comprising:
a receiver for receiving content including at least one of a scene element and a scene element set that includes the scene element, for use in scene composition according to at least one of a terminal type, a user preference, and a content-serviced party;
a scene composition controller for selecting at least one of the at least one of the scene element and the scene element set included in the content according to the at least one of the terminal type, the user preference, and the content-serviced party; and
a scene composer for composing a scene using the selected at least one of the at least one of the scene element and the scene element set.

11. The apparatus of claim 10, wherein the terminal type is classified according to at least one of a characteristic, capability, status, and condition of a terminal.

12. The apparatus of claim 11, wherein the terminal type is classified according to at least one of a display size, a Central Processing Unit (CPU) processing capability, a remaining battery power, and an available memory capacity of the terminal.

13. A method for transmitting content, comprising:
generating content including at least one of a scene element and a scene element set that includes the scene element, for use in scene composition;
generating content including at least one of a scene element and a scene element set that includes the scene element according to an event indicating a change in at least one of a terminal type, a user preference, and a content-serviced party, when generation of the event is signaled by a receiver;
encoding the contents; and
transmitting the encoded contents.

14. The method of claim 13, wherein each of the contents includes the at least one of the scene element and the scene element set that includes the scene element according to the at least one of the terminal type, the user preference, and the content-serviced party.

15. The method of claim 13, wherein each of the contents further includes priority levels of scene elements.

16. The method of claim 13, wherein each of the contents further includes at least one alternative scene element for substituting the at least one of the scene element and the scene element set.

17. The method of claim 13, wherein the terminal type is classified according to at least one of a characteristic, capability, status, and condition of a terminal.

18. The method of claim 17, wherein the terminal type is classified according to at least one of a display size, a Central Processing Unit (CPU) processing capability, a remaining battery power, and an available memory capacity of the terminal.

19. An apparatus for transmitting content, comprising:
a contents generator for generating content including at least one of a scene element and a scene element set that includes the scene element, for use in scene composition, and generating content including at least one of a scene element and a scene element set that includes the scene element according to an event indicating a change in at least one of a terminal type, a user preference, and a content-serviced party, when generation of the event is signaled by a receiver;
an encoder for encoding the contents; and
a transmitter for transmitting the encoded contents.

20. The apparatus of claim 19, wherein each of the contents includes the at least one of the scene element and the scene element set that includes the scene element according to the at least one of the terminal type, the user preference, and the content-serviced party.

21. The apparatus of claim 19, wherein each of the contents further includes priority levels of scene elements.

22. The apparatus of claim 19, wherein each of the contents further includes at least one alternative scene element for substituting the at least one of the scene element and the scene element set.

23. The apparatus of claim 19, wherein the terminal type is classified according to at least one of a characteristic, capability, status, and condition of a terminal.

24. The apparatus of claim 23, wherein the terminal type is classified according to at least one of a display size, a Central Processing Unit (CPU) processing capability, a remaining battery power, and an available memory capacity of the terminal.

25. A method for receiving content, comprising:
receiving content;
composing a scene according to a scene composition indicated by the content; and
composing a scene by selecting at least one of a scene element and a scene element set included in the content according to an event indicating a change in at least one of a terminal type, a user preference, and a content-serviced party, when the event occurs.

26. The method of claim 25, wherein the content includes the at least one of the scene element and the scene element set that includes the scene element according to the at least one of the terminal type, the user preference, and the content-serviced party.

27. The method of claim 25, wherein the content further includes priority levels of scene elements.

28. The method of claim 25, wherein the content further includes at least one alternative scene element for substituting the at least one of the scene element and the scene element set.

29. The method of claim 25, wherein the terminal type is classified according to at least one of a characteristic, capability, status, and condition of a terminal.

30. The method of claim 29, wherein the terminal type is classified according to at least one of a display size, a Central Processing Unit (CPU) processing capability, a remaining battery power, and an available memory capacity of the terminal.

31. An apparatus for receiving content, comprising:
a receiver for receiving content;
a scene composition controller for selecting at least one of a scene element and a scene element set included in the content according to an event indicating a change in at least one of a terminal type, a user preference, and a content-serviced party, when the event occurs; and
a scene composer for composing a scene using the selected at least one of the scene element and the scene element set.

32. The apparatus of claim 31, wherein the content includes the at least one of the scene element and the scene element set that includes the scene element according to the at least one of the terminal type, the user preference, and the content-serviced party.

33. The apparatus of claim 31, wherein the content further includes priority levels of scene elements.

34. The apparatus of claim 31, wherein the content further includes at least one alternative scene element for substituting the at least one of the scene element and the scene element set.

35. The apparatus of claim 31, wherein the terminal type is classified according to at least one of a characteristic, capability, status, and condition of a terminal.

36. The apparatus of claim 35, wherein the terminal type is classified according to at least one of a display size, a Central Processing Unit (CPU) processing capability, a remaining battery power, and an available memory capacity of the terminal.

37. A method for transmitting content, comprising:
generating content including at least one of a scene element and a scene element set that includes the scene element, and priority levels of scene elements, for use in scene composition;
encoding the content; and
transmitting the encoded content.

38. The method of claim 37, wherein the content includes the at least one of the scene element and the scene element set that includes the scene element according to at least one of a terminal type, a user preference, and a content-serviced party.

39. The method of claim 38, wherein the terminal type is classified according to at least one of a characteristic, capability, status, and condition of a terminal.

40. The method of claim 39, wherein the terminal type is classified according to at least one of a display size, a Central Processing Unit (CPU) processing capability, a remaining battery power, and an available memory capacity of the terminal.

41. An apparatus for transmitting content, comprising:
a content generator for generating content including at least one of a scene element and a scene element set that includes the scene element, and priority levels of scene elements, for use in scene composition;
an encoder for encoding the content; and
a transmitter for transmitting the encoded content.

42. The apparatus of claim 41, wherein the content includes the at least one of the scene element and the scene element set that includes the scene element according to at least one of a terminal type, a user preference, and a content-serviced party.

43. The apparatus of claim 42, wherein the terminal type is classified according to at least one of a characteristic, capability, status, and condition of a terminal.

44. The apparatus of claim 43, wherein the terminal type is classified according to at least one of a display size, a Central Processing Unit (CPU) processing capability, a remaining battery power, and an available memory capacity of the terminal.

45. A method for receiving content, comprising:
receiving content including at least one of a scene element and a scene element set that includes the scene element, and priority levels of scene elements, for use in scene composition; and
composing a scene by selecting at least one of the at least one of the scene element and the scene element set, and the priority levels of scene elements according to at least one of a terminal type, a user preference, and a content-serviced party.

46. The method of claim 45, wherein the content includes the at least one of the scene element and the scene element set having the scene element according to the at least one of the terminal type, the user preference, and the content-serviced party.

47. The method of claim 45, wherein the terminal type is classified according to at least one of a characteristic, capability, status, and condition of a terminal.

48. The method of claim 47, wherein the terminal type is classified according to at least one of a display size, a Central Processing Unit (CPU) processing capability, a remaining battery power, and an available memory capacity of the terminal.

49. An apparatus for receiving content, comprising:
a receiver for receiving content including at least one of a scene element and a scene element set that includes the scene element, and priority levels of scene elements, for use in scene composition;
a scene composition controller for selecting at least one of the at least one of the scene element and the scene element set, and the priority levels of scene elements according to at least one of a terminal type, a user preference, and a content-serviced party; and
a scene composer for composing a scene using the selected at least one of the at least one of the scene element and the scene element set, and the priority levels of scene elements.

50. The apparatus of claim 49, wherein the content includes the at least one of the scene element and the scene element set that includes the scene element according to the at least one of the terminal type, the user preference, and the content-serviced party.

51. The apparatus of claim 49, wherein the terminal type is classified according to at least one of a characteristic, capability, status, and condition of a terminal.

52. The apparatus of claim 51, wherein the terminal type is classified according to at least one of a display size, a Central Processing Unit (CPU) processing capability, a remaining battery power, and an available memory capacity of the terminal.

53. A method for transmitting content, comprising:
generating content including at least one of a scene element and a scene element set that includes the scene element, and at least one alternative scene element for substituting for the at least one of the scene element and the scene element set, for use in scene composition;
encoding the content; and
transmitting the encoded content.

54. The method of claim 53, wherein the content includes the at least one of the scene element and the scene element set that includes the scene element according to at least one of a terminal type, a user preference, and a content-serviced party.

55. The method of claim 54, wherein the terminal type is classified according to at least one of a characteristic, capability, status, and condition of a terminal.

56. The method of claim 55, wherein the terminal type is classified according to at least one of a display size, a Central Processing Unit (CPU) processing capability, a remaining battery power, and an available memory capacity of the terminal.

57. An apparatus for transmitting content, comprising:
a contents generator for generating content including at least one of a scene element and a scene element set that includes the scene element, and at least one alternative scene element for substituting for the at least one of the scene element and the scene element set, for use in scene composition;
an encoder for encoding the content; and
a transmitter for transmitting the encoded content.

58. The apparatus of claim 57, wherein the content includes the at least one of the scene element and the scene element set that includes the scene element according to at least one of a terminal type, a user preference, and a content-serviced party.

59. The apparatus of claim 58, wherein the terminal type is classified according to at least one of a characteristic, capability, status, and condition of a terminal.

60. The apparatus of claim 59, wherein the terminal type is classified according to at least one of a display size, a Central Processing Unit (CPU) processing capability, a remaining battery power, and an available memory capacity of the terminal.

61. A method for receiving content, comprising:
receiving content including at least one of a scene element and a scene element set that includes the scene element, and at least one alternative scene element for substituting for the at least one of the scene element and the scene element set, for use in scene composition; and
composing a scene by selecting at least one of the at least one of the scene element and the scene element set and the at least one alternative scene element according to at least one of a terminal type, a user preference, and a content-serviced party.

62. The method of claim 61, wherein the content includes the at least one of the scene element and the scene element set that includes the scene element according to the at least one of the terminal type, the user preference, and the content-serviced party.

63. The method of claim 61, wherein the terminal type is classified according to at least one of a characteristic, capability, status, and condition of a terminal.

64. The method of claim 63, wherein the terminal type is classified according to at least one of a display size, a Central Processing Unit (CPU) processing capability, a remaining battery power, and an available memory capacity of the terminal.

65. An apparatus for receiving content, comprising:
a receiver for receiving content including at least one of a scene element and a scene element set that includes the scene element, and at least one alternative scene element for substituting for the at least one of the scene element and the scene element set, for use in scene composition;
a scene composition controller for selecting at least one of the at least one of the scene element and the scene element set and the at least one alternative scene element according to at least one of a terminal type, a user preference, and a content-serviced party; and
a scene composer for composing a scene using the selected at least one of the at least one of the scene element and the scene element set and the at least one alternative scene element.

66. The apparatus of claim 65, wherein the content includes the at least one of the scene element and the scene element set that includes the scene element according to the at least one of the terminal type, the user preference, and the content-serviced party.

67. The apparatus of claim 66, wherein the terminal type is classified according to at least one of a characteristic, capability, status, and condition of a terminal.

68. The apparatus of claim 67, wherein the terminal type is classified according to at least one of a display size, a Central Processing Unit (CPU) processing capability, a remaining battery power, and an available memory capacity of the terminal.

69. A method for transmitting content, comprising:
generating content including at least one of a scene element and a scene element set that includes the scene element, for use in scene composition;
encoding the content; and
transmitting the encoded content.

70. The method of claim 69, wherein the content includes the at least one of the scene element and the scene element set that includes the scene element according to at least one of a terminal type, a user preference, and a content-serviced party.

71. The method of claim 69, wherein the content generation comprises generating content including at least one of a scene element and a scene element set having the scene element according to an event indicating a change in at least one of a terminal type, a user preference, and a content-serviced party, when generation of the event is notified of by a receiver.

72. The method of claim 69, wherein the content further includes priority levels of scene elements.

73. The method of claim 69, wherein the content further includes at least one alternative scene element for substituting the at least one of the scene element and the scene element set.

74. The method of claim 70, wherein the terminal type is classified according to at least one of a characteristic, capability, status, and condition of a terminal.

75. The method of claim 74, wherein the terminal type is classified according to at least one of a display size, a Central Processing Unit (CPU) processing capability, a remaining battery power, and an available memory capacity of the terminal.

76. An apparatus for transmitting content, comprising:
a contents generator for generating content including at least one of a scene element and a scene element set that includes the scene element, for use in scene composition;
an encoder for encoding the content; and
a transmitter for transmitting the encoded content.

77. The apparatus of claim 76, wherein the content includes the at least one of the scene element and the scene element set that includes the scene element according to at least one of a terminal type, a user preference, and a content-serviced party.

78. The apparatus of claim 76, wherein the content generator generates content including at least one of a scene element and a scene element set that includes the scene element according to an event indicating a change in at least one of a terminal type, a user preference, and a content-serviced party, when generation of the event is notified of by a receiver.

79. The apparatus of claim 76, wherein the content further includes priority levels of scene elements.

80. The apparatus of claim 76, wherein the content further includes at least one alternative scene element for substituting the at least one of the scene element and the scene element set.

81. The apparatus of claim 77, wherein the terminal type is classified according to at least one of a characteristic, capability, status, and condition of a terminal.

82. The apparatus of claim 78, wherein the terminal type is classified according to at least one of a characteristic, capability, status, and condition of a terminal.

83. The apparatus of claim 81, wherein the terminal type is classified according to at least one of a display size, a Central Process Unit (CPU) processing capability, a remaining battery power, and an available memory capacity of the terminal.

84. A method for receiving content, comprising:
receiving content including at least one of a scene element and a scene element set that includes the scene element, for use in scene composition; and
composing a scene by selecting at least one of the at least one of the scene element and the scene element set included in the content according to at least one of a terminal type, a user preference, and a content-serviced party.

85. The method of claim 84, wherein the content includes the at least one of the scene element and the scene element set that includes the scene element according to the at least one of the terminal type, the user preference, and the content-serviced party.

86. The method of claim 84, wherein the scene composition comprises composing a scene by selecting at least one of the at least one of the scene element and the scene element set included in the content according to an event indicating a change in the at least one of the terminal type, the user preference, and the content-serviced party, when the event occurs.

87. The method of claim 84, wherein the content further includes priority levels of scene elements.

88. The method of claim 84, wherein the content further includes at least one alternative scene element for substituting the at least one of the scene element and the scene element set.

89. The method of claim 84, wherein the terminal type is classified according to at least one of a characteristic, capability, status, and condition of a terminal.

90. The method of claim 89, wherein the terminal type is classified according to at least one of a display size, a Central Processing Unit (CPU) processing capability, a remaining battery power, and an available memory capacity of the terminal.

91. An apparatus for receiving content, comprising:
a receiver for receiving content including at least one of a scene element and a scene element set that includes the scene element, for use in scene composition;
a scene composition controller for selecting at least one of the at least one of the scene element and the scene element set included in the content according to at least one of a terminal type, a user preference, and a content-serviced party; and
a scene composer for composing a scene using the selected at least one of the at least one of the scene element and the scene element set.

92. The apparatus of claim 91, wherein the content includes the at least one of the scene element and the scene element set that includes the scene element according to the at least one of the terminal type, the user preference, and the content-serviced party.

93. The apparatus of claim 91, wherein the scene composer composes a scene by selecting at least one of the at least one of the scene element and the scene element set included in the content according to an event indicating a change in the at least one of the terminal type, the user preference, and the content-serviced party, when the event occurs.

94. The apparatus of claim 91, wherein the content further includes priority levels of scene elements.

95. The apparatus of claim 91, wherein the content further includes at least one alternative scene element for substituting the at least one of the scene element and the scene element set.

96. The apparatus of claim 91, wherein the terminal type is classified according to at least one of a characteristic, capability, status, and condition of a terminal.

97. The apparatus of claim 96, wherein the terminal type is classified according to at least one of a display size, a Central Processing Unit (CPU) processing capability, a remaining battery power, and an available memory capacity of the terminal.
